(19) United States
(12) Patent Application Publication
(10) Pub. No.: US 2025/0028103 A1
(43) Pub. Date: Jan. 23, 2025

(54) Film Having Spatially Varying Layer

(71) Applicant: 3M INNOVATIVE PROPERTIES COMPANY, St. Paul, MN (US)

(72) Inventors: Stephen A. Johnson, Woodbury, MN (US); William T. Fay, Woodbury, MN (US); Michael Benton Free, Stillwater, MN (US); Atheen R. Johnson, Woodbury, MN (US); Derek W. Patzman, Prior Lake, MN (US)

(21) Appl. No.: 18/684,773

(22) PCT Filed: Aug. 12, 2022
(86) PCT No.: PCT/IB2022/057574

§ 371 Date: Feb. 19, 2024

Related U.S. Application Data
(60) Provisional application No. 63/240,558, filed on Sep. 3, 2021.

(51) Int. Cl. G02B 5/28

(52) U.S. Cl. CPC G02B 5/285

(57) ABSTRACT

A film includes a first layer having a substantially constant thickness. The first layer extends substantially uniformly along a length direction of the first layer and includes adjacent continuous first and second portions extending along the length direction. Each of the first and second portions includes a substantially constant thickness portion extending to an edge of the first layer along a width direction of the first layer, and a tapering portion adjacent the substantially constant thickness portion and having a thickness tapering in the width direction to a minimum thickness at an end of the tapering portion opposite the substantially constant thickness portion. The minimum thickness can be less than 20% of a thickness of the substantially constant thickness portion. The tapering portions of the first and second portions can have respective first and second major surfaces substantially conforming to one another.

### SUMMARY

In some aspects, the present description provides a film including a first layer having a substantially constant thickness. The first layer extends substantially uniformly along a length direction of the first layer and includes adjacent continuous first and second portions extending along the length direction. Each of the first and second portions includes a substantially constant thickness portion extending to an edge of the first layer along a width direction of the first layer orthogonal to the length direction and to a thickness direction of the first layer; and a tapering portion adjacent the substantially constant thickness portion, the tapering portion having a thickness tapering in the width direction to a minimum thickness at an end of the tapering portion opposite the substantially constant thickness portion. The minimum thickness can be less than 20% of a thickness of the substantially constant thickness portion. The tapering portions of the first and second portions can have respective first and second major surfaces substantially conforming to one another.

In some aspects, the present description provides a film including a first layer having a substantially constant thickness. The first layer extends substantially uniformly along a length direction of the first layer and includes adjacent first and second portions extending along the length direction. The first and second portions each include a substantially constant thickness portion having a substantially same thickness T and a tapering portion having a thickness tapering to a zero thickness at an end of the tapering portion opposite the substantially constant thickness portion. The tapering portions of the first and second portions have respective first and second major surfaces substantially conforming to one another. The first and second major surfaces extend across a width W in a width direction of the first layer orthogonal to the length direction. W can be greater than or equal to 2 T.

In some aspects, the present description provides a film including a first layer having a substantially constant thickness. The first layer extends substantially uniformly along a length direction of the first layer and includes adjacent continuous first and second portions extending along the length direction. Each of the first and second portions includes a tapering portion having a thickness tapering in a width direction of the first layer. The width direction is orthogonal to each of the length direction and a thickness direction of the first layer. Each tapering portion tapers from a maximum thickness of the tapering portion to a minimum thickness of the tapering portion of less than 90% of the maximum thickness of the tapering portion. Each tapering portion may substantially continuously taper along the width direction over a distance greater than half of a width of the first layer along the width direction. The tapering portions of the first and second portions have respective first and second major surfaces substantially conforming to one another.

In some aspects, the present description provides a film including a first layer having a substantially constant thickness and extending substantially uniformly along a length direction of the first layer. The first layer includes first and second edge regions extending along the length direction and spaced apart along a width direction of the first layer and a transition region disposed therebetween. The first and second edge regions are disposed adjacent to opposite first and second edges, respectively, of the first layer. The transition region has a width along the width direction greater than an average thickness of the first layer along a thickness direction orthogonal to the length and width directions. The first layer has a first physical property where the first physical property has different substantially constant first and second values V1 and V2 in the respective first and second edge regions. The first physical property may vary substantially monotonically and substantially continuously from the first value V1 to the second value V2 across the width of the transition region.

In some aspects, the present description provides a film including adjacent first and second layers extending substantially uniformly along a length direction of the film and being substantially coextensive with one another. Each of the first and second layers has a thickness varying along a width direction orthogonal to the length direction such that a combined thickness of the first and second layers is substantially constant along the width direction. Each of the first and second layers has a maximum thickness at least 1.2 times a minimum thickness of the layer. The first and second layers have different compositions and may be substantially permanently bonded to one another.

In some aspects, the present description provides a film including first through fourth layers extending substantially uniformly along a length direction of the film and being substantially coextensive with one another. Each of the first through fourth layers has a thickness varying along a width direction orthogonal to the length direction such that each of a combined thickness of the first and second layers and a combined thickness of the third and fourth layers is substantially constant along the width direction. Each of the first through fourth layers can have a maximum thickness at least 1.2 times a minimum thickness of the layer. The first and second layers are adjacent to one another and have different compositions, and the third and fourth layers are adjacent to one another and have different compositions.

In some aspects, the present description provides a film including a first layer having opposing first and second major surfaces separated along a thickness direction of the film. The first layer includes first, second and third portions extending between the first and second major surfaces and being substantially coextensive with the first layer along a length direction of the film. The first and third portions are separated along a width direction of the film and are disposed adjacent to respective opposing first and second lateral edges of the first layer. The width direction is orthogonal to the length and thickness directions. The second portion is disposed between and contacts the first and third portions. The second portion extends substantially uniformly over a width W0 along the width direction of the film. The first layer has an average thickness T. W0/T can be greater than 100. The first, second, and third portions comprise respective first, second, and third compositions where the second composition is different from each of the first and third compositions.

In some aspects, the present description provides a film including a coextruded plurality of polymeric layers extending along a length direction of the film. The plurality of polymeric layers includes a birefringent first layer and a second layer disposed on the first layer. The second layer has opposing first and second major surfaces separated along a thickness direction of the film and includes adjacent first and second portions extending between the first and second major surfaces and being substantially coextensive with the second layer along the length direction. The first and second portions have different compositions.

In some aspects, the present description provides a film including substantially coextensive first, second, and third layers extending substantially uniformly along a length direction of the film. The third layer is disposed between the first and second layers. The third layer includes first and second portions substantially coextensive with the third layer along the length direction and arranged along a width direction orthogonal to the length direction. The first and second portions can have different bond strengths with the first layer. Each of the first and second portions can have a bond strength with the second layer greater than each of the different bond strengths with the first layer.

In some aspects, the present description provides a method of making a film. The method includes extruding first and second thermoplastic polymer compositions through a die along a length direction to form a layer of the film. The die includes adjacent first and second profiled gaps defining respective first and second portions of the layer. Each of the first and second portions including a tapering portion having a thickness tapering in a width direction orthogonal to the thickness direction. The tapering portions of the first and second portions can have respective first and second major surfaces substantially conforming to one another.

In some aspects, the present description provides a method of making a film. The method includes directing first and second molten polymeric compositions across opposing respective first and second major surfaces of a first portion of a shaped spacer element to define a first molten stream having a shaped interface between the first and second molten polymeric compositions; and extruding the first molten stream to form at least one first layer of the film.

In some aspects, the present description provides a method of making a film. The film includes at least first, second, and third layers where the third layer is disposed between the first and second layers and where the third layer includes first and second portions. The method includes coextruding the at least first, second, and third layers. Coextruding the at least first, second, and third layers includes coextruding at least the first and second portions to form the third layer. The first and second portions can have different bond strengths with the first layer. Each of the first and second portions can have a bond strength with the second layer greater than each of the different bond strengths with the first layer.

These and other aspects will be apparent from the following detailed description. In no event, however, should this brief summary be construed to limit the claimable subject matter.

### BRIEF DESCRIPTION OF THE DRAWINGS

FIGS. 1-5 are schematic cross-sectional views of films, according to some embodiments.

FIG. 6 is a schematic illustration of a composition, according to some embodiments.

FIG. 7 is a schematic plot of physical properties of a film or layer as a function of position along a width of the film or layer, according to some embodiments.

FIG. 8 is a schematic illustration of light substantially normally incident on a layer or film, according to some embodiments.

FIG. 9 is a plot of transmittance versus position along a width direction for an exemplary film.

FIG. 10 is a schematic cross-sectional view of a film including adjacent first and second layers, according to some embodiments.

FIG. 11 is a schematic cross-sectional view of a film including at least first through fourth layers, according to some embodiments.

FIG. 12 is a schematic cross-sectional view of a film including alternating layers, according to some embodiments.

FIGS. 13-14 are schematic cross-sectional views of films that each include a plurality of portions extending along a length direction of the film, according to some embodiments.

FIG. 15 is a schematic cross-sectional view of a film including the layer of FIG. 12 and an additional layer, according to some embodiments.

FIG. 16 is a schematic cross-sectional view of a film including the layer of FIG. 12 and two additional layers, according to some embodiments.

FIG. 17 is a schematic cross-sectional view of a multilayer film including a plurality of the films of FIG. 16, according to some embodiments.

FIG. 18A is a schematic perspective view of a portion of a feed block including profiled gaps for forming a layer having a gradual transition between portions on opposite lateral sides of the layer, according to some embodiments.

FIG. 18B is a schematic end view of a portion of the feed block of FIG. 18A.

FIG. 19A is a schematic exploded view of a skin die, according to some embodiments.

FIG. 19B is an enlarged schematic perspective view of a portion of a plate of the skin die of FIG. 19A.

FIG. 19C is a schematic perspective view of fluid flow paths created in the skin die of FIG. 19A.

FIG. 19D is a schematic perspective view of a portion of a plate, according to some embodiments, that may be used in place of the plate in the skin die of FIG. 19A.

FIG. 20A a schematic perspective view of fluid flow paths created in a feed block, according to some embodiments.

FIG. 20B is a schematic perspective view of a portion of the fluid flow paths of FIG. 20A.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some embodiments of the present description, a film or at least one layer within a film has one or more physical properties that varies across a width of the film or layer. The one or more properties of the film can include, for example, one or more of optical (e.g., refractive index, haze, color, etc.), mechanical (e.g., extensibility, stiffness, modulus, etc.), chemical or physicochemical (e.g., adhesion, release, vapor transmission, etc.), electrical (e.g., sheet resistance, dielectric constant, etc.), or thermal (e.g., thermal conductivity, thermal diffusivity, etc.) properties. For example, the film or layer can transition from clear to colored or from transparent to translucent or opaque. Such films may be useful in glazing applications, privacy applications, or other light control applications, for example. As another example, a film can include a layer having a peel strength with an adjacent layer that varies across the width of the layer. In some embodiments, the layer can exhibit very low peel forces (e.g., similar to release liners) with an adjacent layer in certain portion(s) of the layer and substantially higher peel forces in other portion(s) of the layer. A film may include a plurality of such layers to allow successive delamination of layer(s) from the film which may be desired in a variety of applications.

According to some embodiments of the present description, a film or at least one layer within a film includes a transition from one composition to another across a width of the film or layer. The film can be extruded along a length direction of the film with the width direction being in a cross-web direction orthogonal to the length direction. In some embodiments, the transition provides a continuous variation in one or more properties of the film along the width direction from one side of the film to an opposite side. The transition may occur over a width substantially greater than a thickness of the film or layer to provide a gradual transition in one or more properties that may be desired. Alternatively, in some embodiments, there may be one or more abrupt or discontinuous transitions in one or more properties.

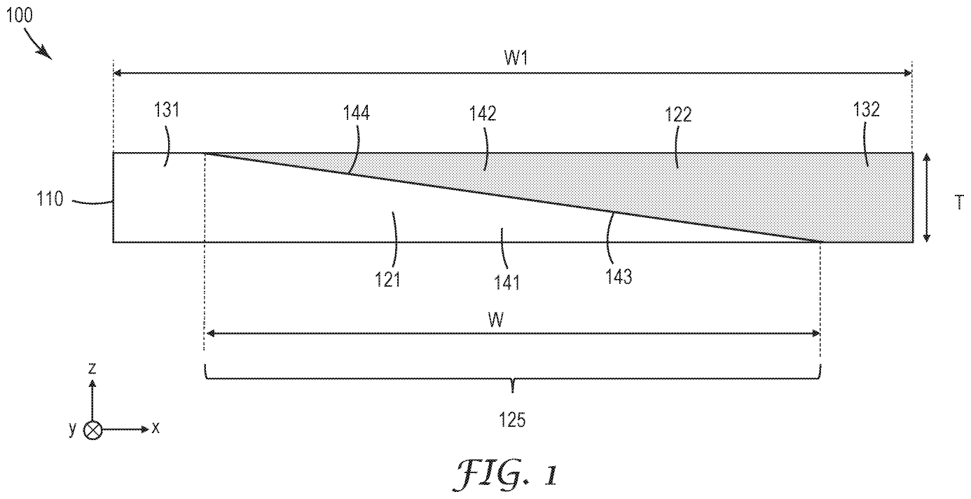

FIGS. 1-5 are schematic cross-sectional views of films 100, 100′, 100″, 100′″, 100″″ including include a respective first layer 110, 110′, 110″, 110′″, 100″″ according to some embodiments. In some embodiments, the first layer 110, 110′, 110″, 110′″, 100″″ extends substantially uniformly along a length direction (y-direction) of the first layer and includes adjacent continuous first and second portions 121 and 122 extending along the length direction. A layer extending substantially uniformly along the length direction can have, for example, a width that varies by less than about 20%, or less than about 10%, or less than about 5% along the length direction; a thickness that varies by less than about 20%, or less than about 10%, or less than about 5% along the length direction for each location across at least about 80% or at least about 90% of the width; and a composition that is substantially uniform along the length direction for each location across at least about 80% or at least about 90% of each of the width and thickness of the layer. The first and second portions 121 and 122 each includes a tapering portion 141, 142 and may each include a substantially constant thickness portion 131, 132. In some embodiments, the first layer 110, 110′, 110″, 110′″, 100″″ has a substantially constant thickness. A substantially constant thickness portion or layer or film may have a thickness that varies by less than about 15%, or less than about 10%, or less than about 5% in cross-sections orthogonal to the length direction or across the length and width of the film, or the thickness may be a nominally constant thickness, for example.

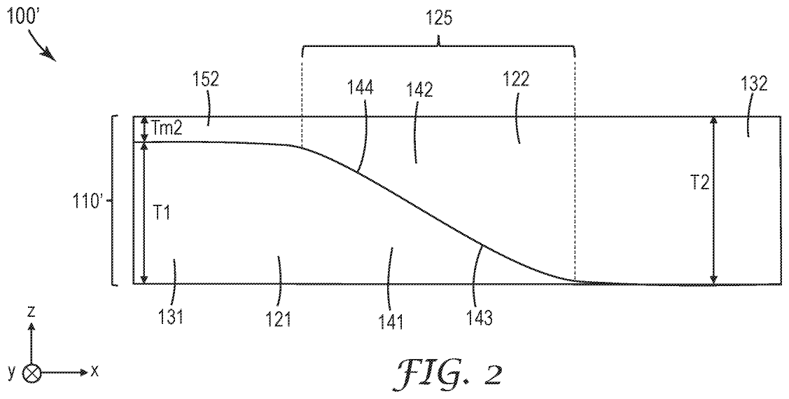

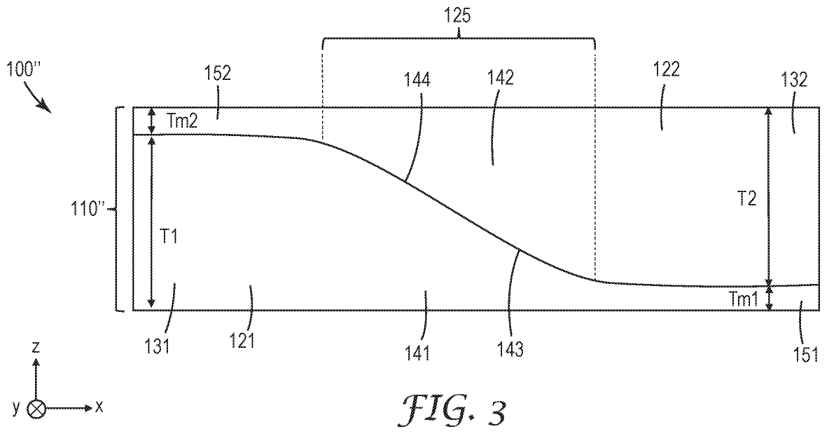

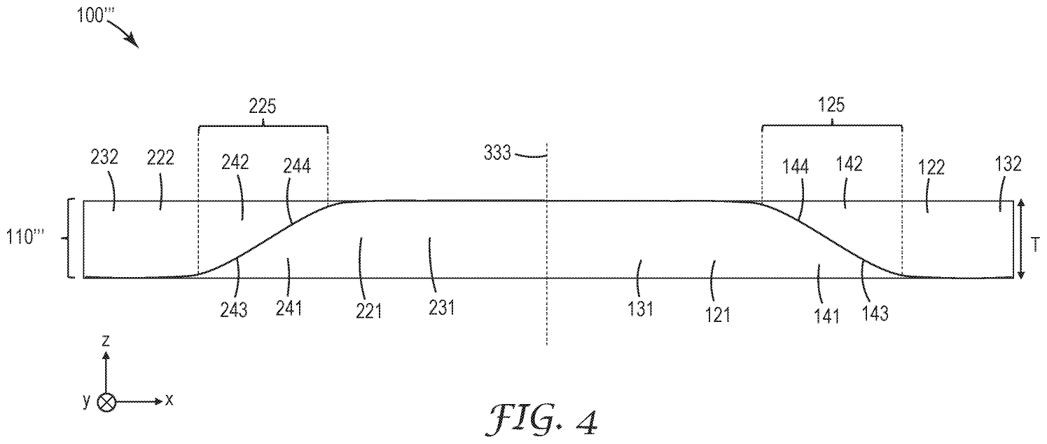

In some embodiments, the substantially constant thickness portion 131, 132 extends to an edge of the first layer along a width direction (x-direction) of the first layer orthogonal to the length direction and to a thickness direction (z-direction) of the first layer. In some embodiments, each of the substantially constant thickness portions 131, 132 extend along the width direction over at least about 5%, or about 10%, or about 15% of a width W1 of the first layer along the width direction. Each substantially constant thickness portions 131, 132 may extend along the width direction up to about 45%, or about 40%, or about 35%, or about 30%, or about 25% of the width W1 of the first layer. In some embodiments, each of the substantially constant thickness portions 131, 132 extend along the width direction over at least about 3%, or at least about 5%, or at least about 7%, or at least about 10% of the width W1 of the first layer. In some embodiments, the tapering portion 141, 142 is adjacent the substantially constant thickness portion 131, 132, respectively, and has a thickness tapering in the width direction to a minimum thickness at an end of the tapering portion opposite the substantially constant thickness portion, where the minimum thickness can be less than 20%, or less than 10%, or less than 5% of a thickness of the substantially constant thickness portion. The tapering portion can taper from the substantially constant thickness portion to the minimum thickness of tapering portion. Tapering in thickness generally refers to a gradual, monotonic decrease in the thickness. The tapering can be linear or non-linear and can occur over a transition region 125 or 225 (see, e.g., FIG. 4). In some embodiments, for at least one of the first and second portions 121 and 122, the minimum thickness is zero. In some embodiments, for each of the first and second portions 121 and 122, the minimum thickness is zero. In some embodiments, for at least one of the first and second portions 121 and 122, the minimum thickness is nonzero. In some embodiments, for each of the first and second portions 121 and 122, the minimum thickness is nonzero. For example, in FIG. 1, the tapering portions 141 and 142 taper to zero thickness; in FIG. 2, the tapering portions 141 and 142 taper to a minimum thickness of zero and Tm2, respectively, where Tm2 can be less than 20% of the thickness T2; and in FIG. 3, the tapering portions 141 and 142 taper to a minimum thickness of Tm1 and Tm2, respectively, where Tm1 and Tm2 can be less than 20% of the respective thicknesses T1 and T2. The tapering portions 141 and 142 of the first and second portions 121 and 122 have respective first and second major surfaces 143 and 144. In some embodiments, the first and second major surfaces 143 and 144 substantially conform (e.g., conform up to deviations on a length scale small compared to the thickness T (e.g., length scale less than 10% of T) or conform up to deviations arising from ordinary manufacturing variations) to one another.

The first and second major surfaces 143 and 144 typically contact one another and may be (e.g., directly) bonded to one another. For example, the first and second major surfaces 143 and 144 may be attached by virtue of the first and second portions 121 and 122 being coextruded together. The strength of the bonding is not particularly limited and can vary from weak to strong bonding depending on the materials used for the first and second portions 121 and 122 (e.g., polymers with similar monomer units tend to bond well to one another, while low surface energy polymers tend to bond weakly with other polymers not having similar monomer units). For example, the first and second major surfaces 143 and 144 may be releasably bonded to one another or may be substantially permanently bonded to one another (e.g., separating the surfaces would damage at least one of the portions 121, 122). In some cases, it may be desired that the surfaces are releasably bonded to one another so that the first and second portions can be removed from one another resulting in a film having a tapering profile (e.g., near an edge of the film) where the taper can be over a width W substantially larger than a thickness T (e.g., W/T can be in any of the ranges described elsewhere herein) of a substantially constant thickness portion of the film. In other embodiments, it is desired the that surfaces be substantially permanently bonded to one another so that the layer 110 including both portions 121 and 122 remains intact.

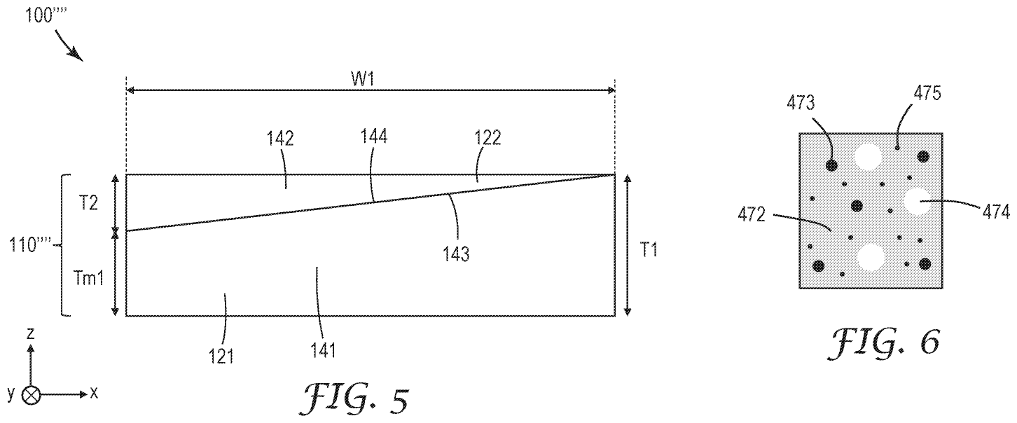

In some embodiments, each of the first and second portions 121 and 122 extend in the width direction across only a portion of an entire width of the first layer (see, e.g., FIGS. 1 and 4). In some embodiments, each of the first and second portions 121 and 122 extends in the width direction across an entire width of the first layer (see, e.g., FIGS. 3 and 5). In some embodiments, one, but not the other, of the first and second portions 121 and 122 extend in the width direction across an entire width of the first layer (see, e.g., FIG. 2). Each of the first and second portions 121 and 122 can extend substantially uniformly along the entire length of the first layer.

In some embodiments, the substantially constant thickness portion 131, 132 of each of the first and second portions 121 and 122 extends in the thickness direction across an entire thickness of the first layer (see, e.g., FIGS. 1 and 4). In some embodiments, the substantially constant thickness portion of one, but not the other, of the first and second portions 121 and 122 extends in the thickness direction across an entire thickness of the first layer (see, e.g., FIG. 2). In some embodiments, the substantially constant thickness portion 131, 132 of each of the first and second portions 121 and 122 extends in the thickness direction across only a portion of an entire thickness of the first layer (see, e.g., FIG. 3).

In some embodiments, at least one of the first and second portions 121 and 122 includes an extension portion 151 and/or 152 extending in the width direction from the tapering portion opposite the substantially constant thickness portion to an edge of the first layer (see, e.g., FIGS. 2-3). In some embodiments, each of the first and second portions 121 and 122 includes an extension portion 151 and 152 extending in the width direction from the tapering portion opposite the substantially constant thickness portion to an edge of the first layer (see, e.g., FIG. 3). The extension portion 151 and/or 152 can have a substantially constant thickness.

In some embodiments, the substantially constant thickness portion 131 and 132 have a substantially same (e.g., equal to within about 10%, or within about 5%, or within about 3%) thickness T (see, e.g., FIGS. 1 and 4 and FIG. 3 where T1 and T2 may be substantially the same). In some embodiments, each of the tapering portions 141, 142 has a thickness tapering to a zero thickness at an end of the tapering portion opposite the substantially constant thickness portion (see, e.g., FIGS. 1 and 4). The tapering portions 141 and 142 of the first and second portions 121 and 122 can have respective first and second major surfaces 143 and 144 substantially conforming to one another. The first and second major surfaces 143 and 144 may be bonded (releasably or permanently) to one another. In some embodiments, the first and second major surfaces 143 and 144 extend across a width W in a width direction of the first layer orthogonal to the length direction, where W≥2 T. In some embodiments, W is greater than or equal to 3, 5, 10, 20, 50, 80, 100, 200, or 300 times T. W can be up to 1000 T, or up to 10,000 T, or even up to 100,000 T, for example.

In some embodiments, the first layer 110′″ further includes adjacent third and fourth portions 221 and 222 extending along the length direction, where the third and fourth portions 221 and 222 each has a substantially constant thickness portion 231 and 232, respectively, having a substantially same thickness substantially equal to the thickness T and a tapering portion 241 and 242, respectively, having a thickness tapering to a minimum thickness of less than 20% of the thickness T at an end of the tapering portion opposite the substantially constant thickness portion. The tapering portions of the third and fourth portions 221 and 222 have respective third and fourth major surfaces 243 and 244 substantially conforming to one another. The third and fourth major surfaces 243 and 244 may be (e.g., substantially permanently or releasably) bonded to one another. In some embodiments, the film 100′″ is substantially symmetric (e.g., symmetric up to deviations on a length scale small compared to the thickness T (e.g., length scale less than 10% of T) or symmetric up to deviations arising from ordinary manufacturing variations) under reflection about a plane 333 orthogonal to the width direction and bisecting the film.

In some embodiments, each of the first and second portions 121 and 122 includes a tapering portion 141, 142 having a thickness tapering in a width direction (x-direction) of the first layer where the width direction is orthogonal to each of the length direction (y-direction) and a thickness direction (z-direction) of the first layer, and where each tapering portion 141, 142 tapers from a maximum thickness of the tapering portion to a minimum thickness of the tapering portion of less than 90%, or less than 80%, or less than 70% of the maximum thickness of the tapering portion. For example, in FIG. 5, the tapering portion 141 tapers from a maximum thickness of T1 to a minimum thickness of Tm1, and the tapering portion 142 tapers from a maximum thickness T2 to a minimum thickness of zero. In some embodiments, as schematically illustrated in FIG. 5, for example, the minimum thickness of the tapering portion of one, but not the other, of the first and second portions is zero. In some embodiments, each tapering portion substantially continuously tapers along the width direction over a distance greater than half of a width W1 of the first layer along the width direction. For example, the portion 125 can have a width W greater than half the width W1 of the first layer (see, e.g., FIG. 1). In some embodiments, each tapering portion 141, 142 extends over a distance greater than 60, 70, 80, or 90% of the width of the first layer. In FIG. 5, for example, each tapering portion 142, 143 extends over substantially an entire width W1 of the first layer 110″″. In some embodiments, the first and second portions 121 and 122 consist essentially of the respective tapering portions 141 and 142. In other embodiments, one or both of the first and second portions 121 and 122 includes a substantially constant thickness portion adjacent the tapering portion as described further elsewhere herein. In some embodiments, each tapering portion extends over a distance of at least 2, 3, 5, 10, 20, 50, 80, or 100 times a substantially constant thickness of the first layer. Each tapering portion may extend over a distance of up to 100,000, or up to 50,000, or up to 30,000, or up to 10,000 times the thickness of the first layer, for example.

In some embodiments, the tapering portions 141, 142 of the first and second portions 121, 122 have respective first and second major surfaces 143, 144 substantially conforming to one another. The first and second major surfaces 143 and 144 may be bonded to one another. For example, the first and second major surfaces 143 and 144 may be releasably bonded to one another or may be substantially permanently bonded to one another. In some embodiments, the first portion 121 is an adhesive and the second portion 122 is a release layer (e.g., a low surface energy layer with weak bonding to the adhesive). For example, the film 100″″ can be a tape for laminating glass layers together to form a windshield where the first portion 121 is an adhesive layer configured to provide a predetermined tilt of the glass layers which may be used to reduce ghosting in a heads up display projected from the windshield, for example.

In some embodiments, at least one of the first and second portions 121, 122 (and/or at least one of the third and fourth portion 231, 232) is substantially uniformly birefringent. For example, a magnitude of a birefringence of the portion can vary by less than 10% or less than 5% over at least 80% or 90% of the portion and an orientation of a same principal axis (slow axis or fast axis) of the birefringence can vary by less than 20 degrees or less than 10 degrees over at least 80% or 90% of the portion. A substantially uniformly birefringent portion may have an average birefringence of at least 0.05 or the average birefringence can be in any range described elsewhere herein. The birefringence can be selected by selecting suitable polymers (e.g., semi-crystalline polymers) and suitable processing conditions (e.g., stretching), as described further elsewhere herein.

In some embodiments, the first and second portions 121 and 122 include respective first and second thermoplastic polymers. The first and second thermoplastic polymers can be selected to be readily extrudable and processable. For example, the thermoplastic polymers can be selected to have molecular weights and/or intrinsic viscosities and/or melt flow indices (MFIs) in suitable ranges for extrudability. In some embodiments, each of the first and second thermoplastic polymers has a weight-averaged molecular weight Mw greater than 20,000 Daltons or greater than 35,000 Daltons, or greater than 50,000 Daltons. The weight-averaged molecular weight Mw can be up to 1,000,000 Daltons, or up to 600,000 Daltons or up to 400,000 Daltons, or up to 200,000 Daltons or up to 150,000 Daltons, for example. In some such embodiments, or in other embodiments, each of the first and second thermoplastic polymers has an intrinsic viscosity in range of 0.3 dl/g to 1.2 dl/g or 0.4 dl/g to 1.0 dl/g when measured in a solvent blend comprising 60 weight percent o-chlorobenzene and 40 weight percent phenol. In some such embodiments, or in other embodiments, the thermoplastic polymers have a melt flow index greater than 5 g/10 min, or greater than 10 g/10 min, or greater than 20 g/10 min, for example. The melt flow index may be up to 300 g/10 min, or up to 200 g/10 min, or up to 100 g/10 min, for example. Similarly, the third and fourth portions 221 and 222 can include respective third and fourth thermoplastic polymers that can each have weight-averaged molecular weights in any of these molecular weight ranges and/or intrinsic viscosities in any of these intrinsic viscosity ranges and/or MFIs in any of these MFI ranges. The third portion 221 may have a same or different composition than the first portion 121.

In embodiments where the first and third portions 121 and 221 have the same composition, the first and third portions may define a single continuous portion. The fourth portion 222 may have a same or different composition than the second portion 122. The weight averaged molecular weight Mw can be determined using gel permeation chromatography, for example. The intrinsic viscosity can be determined using a capillary viscometer, for example. The melt flow index, which may alternatively be referred to as melt flow rate, can be determined using an extrusion plastometer according to ASTM D1238-20, for example.

Suitable materials for the various portions or layers or the films of the present description include, for example, polyethylene naphthalate (PEN), coPEN (copolyethylene naphthalate terephthalate copolymer), polyethylene terephthalate (PET), polyhexylethylene naphthalate copolymer (PHEN), glycol-modified PET (PETG), glycol-modified PEN (PENG), syndiotactic polystyrene (sPS), THV (a terpolymer of tetrafluoroethylene, hexafluoropropylene and vinylidene fluoride), polymethyl methacrylate (PMMA), coPMMA (a copolymer of methyl methacrylate and ethyl acrylate), styrenic block copolymers (block copolymers including styrene blocks) such as linear triblock copolymers based on styrene and ethylene/butylene (e.g., styrene-ethylene/butylene-styrene (SEBS) copolymers), acrylic block copolymers (block copolymers including acrylate or methacrylate blocks) such as a linear triblock copolymers based on methyl methacrylate and n-butyl acrylate, anhydride-modified ethylene vinyl acetate polymers, ketone ethylene ester terpolymers, polyolefin thermoplastic elastomer, polypropylene (PP), co-polypropylene (coPP) such as copolymers of propylene and ethylene, urethanes such as thermoplastic polyurethanes (TPUs), or blends thereof.

Atactic polystyrene (aPS) can optionally be blended with sPS (e.g., at about 5 to about 30 weight percent aPS) to adjust the refractive indices of the resulting layer and/or to reduce the haze of the layer (e.g., by reducing a crystallinity of the layer). Suitable THV polymers are described in U.S. Pat. Appl. Pub. No. 2019/0369314 (Hebrink et al.), for example, and include those available under the DYNEON THV tradename from 3M Company (St. Paul, MN). In some embodiments, THV can contain about 35 to about 75 mole percent tetrafluoroethylene, about 5 to about 20 mole percent hexafluoropropylene, and about 15 to about 55 mole percent vinylidene fluoride. Suitable styrenic block copolymers include KRATON G1645 and KRATON G1657 available from KRATON Polymers (Houston, TX). Suitable acrylic block copolymers include those available under the KURARITY tradename from Kuraray Co., Ltd. (Tokyo, JP). PETG can be described as PET with some of the glycol units of the polymer replaced with different monomer units, typically those derived from cyclohexanedimethanol. PETG can be made by replacing a portion of the ethylene glycol used in the transesterification reaction producing the polyester with cyclohexanedimethanol, for example. Suitable PETG copolyesters include GN071 available from Eastman Chemical Company (Kingsport, TN). PEN and coPEN can be made as described in U.S. Pat. No. 10,001,587 (Liu), for example. Low melt PEN is a coPEN including about 90 mole percent naphthalene dicarboxylate groups based on total carboxylate groups and is also known as coPEN 90/10. Another useful coPEN is coPEN 70/30 which includes about 70 mole percent naphthalene dicarboxylate groups and about 30 mole percent terephthalate dicarboxylate groups based on total carboxylate groups. More generally, coPEN Z/100-Z may be used where coPEN Z/100-Z includes Z mole percent naphthalene dicarboxylate groups (typically greater than 50 mole percent and no more than about 90 mole percent) and 100-Z mole percent terephthalate dicarboxylate groups based on total carboxylate groups. Glycol-modified polyethylene naphthalate (PENG) can be described as PEN with some of the glycol units of the polymer replaced with different monomer units and can be made by replacing a portion of the ethylene glycol used in the transesterification reaction producing the polyester with cyclohexanedimethanol, for example. PHEN can be made as described for PEN in U.S. Pat. No. 10,001,587 (Liu), for example, except that a portion of the ethylene glycol (e.g., about 40 mole percent) used in the transesterification reaction is replaced with hexanediol. Suitable PET can be obtained from Nan Ya Plastics Corporation, America (Lake City, SC), for example. Suitable sPS can be obtained from Idemitsu Kosan Co., Ltd. (Tokyo, Japan), for example. Suitable PMMA can be obtained from Arkema Inc., Philadelphia, PA., for example. Suitable anhydride-modified ethylene vinyl acetate polymers include those available from Dow Chemical (Midland, MI) under the BYNEL tradename, for example. Suitable ketone ethylene ester terpolymers include those available from Dow Chemical (Midland, MI) under the BYNEL tradename, for example. Suitable polyolefin thermoplastic elastomers include those available from Mitsui Chemicals (Tokyo, Japan) under the ADMER tradename. Suitable coPP includes PP8650 (random copolymer of propylene and ethylene) available from Total Petrochemicals, Inc. (Huston, TX).

FIG. 6 is a schematic illustration of a composition, according to some embodiments, that can be used in the first and/or second portions 121, 122 and/or the third and/or fourth portions 221, 222, for example. In some embodiments, each of the first and second portions 121 and 122 (and/or the third and fourth portions 221 and 222) has a substantially uniform composition. In some embodiments, the first and second portions 121 and 122 (and/or the third and fourth portions 221 and 222) have different compositions. In some embodiments, each of the different compositions comprise a same first polymer. For example, each compositions can include a polymeric matrix having a same polymer or polymer blend and the compositions can differ in concentrations of dyes, pigments, beads, and/or nanoparticles, for example. In some embodiments, the different compositions have different concentrations of at least one of a dye 472 (schematically represented by shading in FIG. 6), a pigment 473, a bead 474, or a nanoparticle 475. The composition in each of the portions 121, 122, 221, 222 may be substantially uniform (e.g., nominally uniform or having composition concentrations varying by less than about 20, 10, or 5 percent when determined over a length scale large compared to any average particle (e.g., pigment, bead, nanoparticle) to particle separation but small compared to the dimensions (e.g., thickness, width) of the portion).

The composition can include any of the polymers described elsewhere herein and optionally dye, pigments, beads (e.g., for optical diffusion), nanoparticles (e.g., for increasing refractive index or altering mechanical properties which may alter peel strength, for example), or other filler particles. The composition may include phase separated polymers to create haze or other optical phenomena. The composition may include metallic particles (e.g., copper, silver, etc.), for example, for improved electrical and/or thermal conductivity, for example, or for other electrical and/or thermal properties. Suitable beads include glass beads or polymeric beads such as polystyrene beads. Suitable nanoparticles include titania or alumina nanoparticles. Suitable dyes or pigments include, for example, one or more of carbon black; Disperse Blue 60 (C₂₀H₁₇N₃O₅; CAS Number 12217-80-0); Pigment Yellow 147 (C₃₇H₂₁N₅O₄; CAS Number 4118-16-5); red azo dyes such as Red Dye 40 (C₁₈H₁₄N₂Na₂O₈S₂; CAS Number 25956-17-6); anthraquinone dyes or pigments such as Solvent Yellow 163 (C₂₆H₁₆O₂S₂; CAS Number 13676-91-0), Pigment Red 177 (C₂₈H₁₆N₂O₄; CAS Number 4059-63-2), and Disperse Red 60 (C₂₀H₁₃NO₄; CAS Number 12223-37-9); perylene dyes or pigments such as Pigment Black 31 (C₄₀H₂₆N₂O₄; CAS Number 67075-37-0), Pigment Black 32 (C₄₀H₂₆N₂O₆; CAS Number 83524-75-8), and Pigment Red 149 (C₄₀H₂₆N₂O₄; CAS Number 4948-15-6); the blue, yellow, red and cyan dyes PD-325H, PD-335H, PD-104 and PD-318H, respectively, available from Mitsui Fine Chemicals, Tokyo Japan; and CERES Blue XR-RF dye available from Lanxess, Cologne, Germany. In some cases, a mixture of such dyes or pigments may be used to achieve optical absorption throughout a desired wavelength range (e.g., a visible wavelength range extending at least from 420 nm to 680 nm).

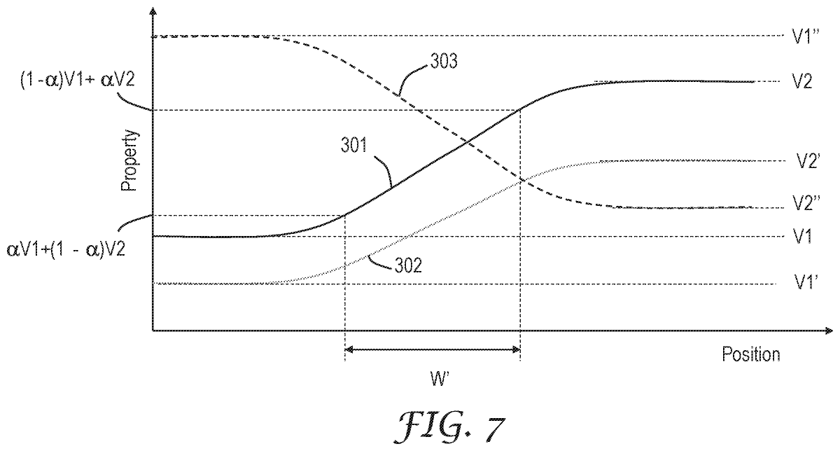

FIG. 7 is a schematic plot of physical properties 301, 302, 303 of a film or layer as a function of position along a width of the film or layer, according to some embodiments. The physical properties may include at least one property that varies substantially continuously along the width direction. The physical properties can include one or more of an optical property (e.g., refractive index, optical haze, color, optical transmittance), a mechanical property (e.g., Young's modulus, extensibility, stiffness), a physicochemical property (e.g., vapor transmission which can depend on the polymers chosen for the various portions of the film or layer, peel strength which can depend on a varying modulus which may result from including nanoparticles in a portion of the film, for example), an electrical property (e.g., sheet resistance, electrical resistance in thickness direction, dielectric constant), or a thermal property (e.g., thermal conductivity, heat capacity, thermal diffusivity). Various physical properties of the film along the width direction can be measured by cutting the film into strips and measuring the physical property for the strip. Various other physical properties (e.g., compressive Young's modulus, various optical properties) can be measured at locations along the width of the intact film (i.e., without cutting the film into strips). The physical properties of the film can vary due to the different portions of the film having different physical properties so that a taper between the different portions results in the physical properties varying across the tapered region.

In some embodiments, the film (e.g., any of 100-100′″) has a first physical property (e.g., 301) varying substantially continuously along the width direction between first and second values (e.g., V1 and V2) in the substantially constant thickness portions of the respective first and second portions 121 and 122. In some embodiments, the film (e.g., any of 100-100′″) also has a second physical property (e.g., 302) varying substantially continuously along the width direction between first and second values (e.g., V1′ and V2′) in the substantially constant thickness portions of the respective first and second portions 121 and 122. In some embodiments, the film (e.g., any of 100-100′″) also has at least a third physical property (e.g., 303) varying substantially continuously along the width direction between first and second values (e.g., V1 “and V2”) in the substantially constant thickness portions of the respective first and second portions 121 and 122. The first and second values may differ by at least 10% (e.g., |V2−V1|/V1 times 100% can be at least 10%), or at least 20% or at least 30%, for example. The first and second values may differ by up to 10,000%, 1000%, 500%, or 200%, for example.

In some embodiments, a film (e.g., any of 100-100″) includes a first layer (e.g., any of 110-110″) extending substantially uniformly along a length direction (y-direction) of the first layer and including first and second edge regions 131, 132 extending along the length direction and spaced apart along a width direction (x-direction) of the first layer and a transition region 125 disposed therebetween, where the first and second edge regions are disposed adjacent opposite first and second edges, respectively, of the first layer. The first and second edge regions 131, 132 and the transition region 125 can extend substantially uniformly along the entire length of the first layer. The first and second edge regions 131, 132 may each have a substantially constant thickness. The transition region 125 has a width W along the width direction greater than an average thickness T of the first layer along a thickness direction orthogonal to the length and width directions. The first and second edge regions may extend to respective opposing edges of the first layer and may each have a width along the width direction greater than an average thickness T of the first layer. The first layer has a first physical property having different substantially constant first and second values V1 and V2 in the respective first and second edge regions. In some embodiments, the first physical property can vary substantially continuously (e.g., nominally continuous or continuous up to local variations that are small compared to the overall change and that may arise from ordinary manufacturing variations, for example) from the first value V1 to the second value V2 across the width of the transition region 125. In some such embodiments, or in other embodiments, the first physical property can vary substantially monotonically (e.g., nominally monotonic or monotonic up to local variations that are small compared to the overall change and that may arise from ordinary manufacturing variations, for example) from the first value V1 to the second value V2 across the width of the transition region 125.

The physical property or properties can vary from α×Va+(1−α)×Vb to (1−α)×Va to α×V2 over a with W′ which can be greater than the thickness T of the first layer, where α can be a number in a range of 0.75 to 0.95 or 0.8 to 0.9, for example, and where Va refers to one of V1, V1′, and V1″ (indicated for V1 in FIG. 7) and Vb refers to a corresponding one of V2, V2′, and V2″ (indicated for V2 in FIG. 7). For example, in some embodiments, the first physical property varies from 0.9×V1+0.1×V2 to 0.9×V2+0.1×V1, or from 0.8×V1+0.2×V2 to 0.8×V2+0.2×V1, over a width W′ greater than the average thickness of the first layer.

In some embodiments, the first physical property is at least one of an optical property, a mechanical property, a physicochemical property (a property that can be described as both a chemical and a physical property), a thermal property, or an electrical property. In some embodiments, the first physical property is an average optical transmittance for substantially normally incident light in a predetermined wavelength range (e.g., 400 nm to 700 nm or 420 nm to 680 nm). The average optical transmittance is the unweighted mean of the transmittance in the predetermined wavelength range. In some embodiments, the first physical property is luminous transmittance. In some embodiments, the first physical property is an optical haze. In some embodiments, the first layer has a second physical property different from the first physical property, where the second physical property has different substantially constant first and second values V1′ and V2′ in the respective first and second edge regions, and the second physical property varies substantially monotonically and substantially continuously from the first value V1′ to the second value V2′ across the width of the transition region. In some embodiments, the first and second physical properties are first and second optical properties. In some embodiments, the first optical property is an average optical transmittance for substantially normally incident light in a predetermined wavelength range and the second optical property is an optical haze.

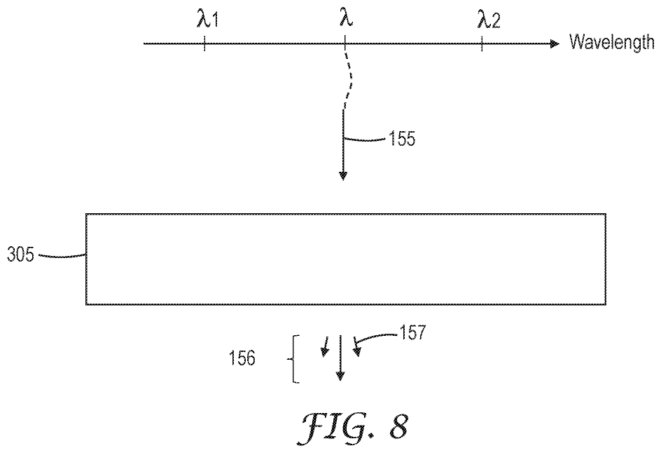

FIG. 8 is a schematic illustration of a light 155 substantially normally incident (e.g., within 20 degrees, or 10 degrees, or 5 degrees of normally incident) on a layer or film 305. The layer or film 305 can correspond to any layer or film described elsewhere herein (e.g., any of layers or films 110-110″″ or 100-100″″). The light 155 has a wavelength λ in a range of λ1 (e.g., 400 nm or 420 nm) to λ2 (e.g., 700 nm or 680 nm). At least a portion of the light 155 is transmitted as light 156 which may include scattered light 157. Useful optical properties of the layer or film 305 may include optical transmittance (see, e.g., transmitted light 156) for substantially normally incident light 155 in a predetermined wavelength range (λ1 to λ2), and/or luminous transmittance for substantially normally incident light, and/or optical haze (see, e.g., scattered light 157). Optical haze and/or luminous transmittance can be determined according to the ASTM D1003-13 test standard, for example.

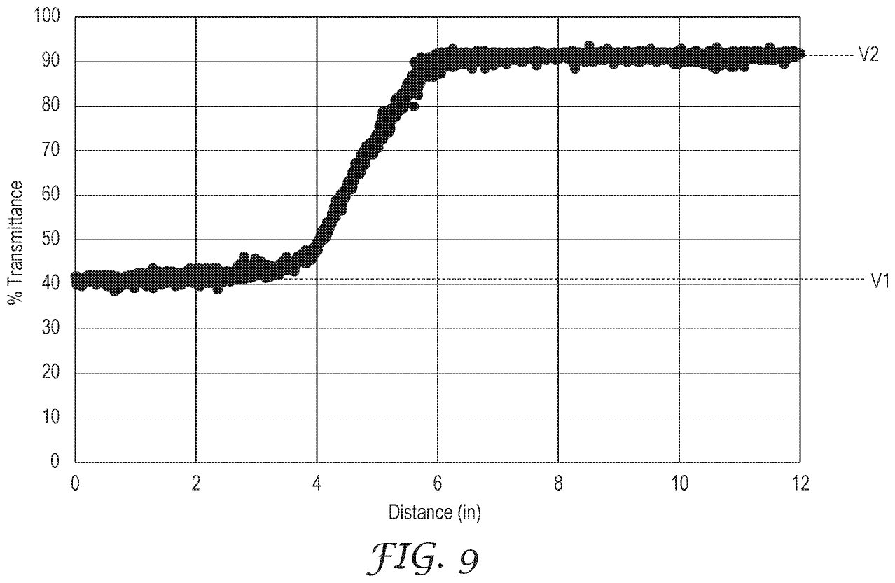

FIG. 9 is a plot of luminous transmittance versus position along the width direction for an example film. In some embodiments, the film has an average optical transmittance for substantially normally incident light in a predetermined wavelength range varying substantially continuously along the width direction between first and second values (e.g., V1 and V2) in the substantially constant thickness portions of the respective first and second portions, where the first and second values of the optical transmittance differ by at least 10% (or in any range described elsewhere herein for differing values). In some such embodiments, or in other embodiments, the film has an optical haze varying substantially continuously along the width direction between first and second values (e.g., V1′ and V2′) in the substantially constant thickness portions of the respective first and second portions, where the first and second values of the optical haze differ by at least 10% (or in any range described elsewhere herein for differing values). In some embodiments, the substantially constant thickness portion having the higher transmittance also has the higher optical haze (e.g., the higher transmittance portion can include beads for scattering light while the other portion can include dyes and/or pigments for reducing transmittance). In some embodiments, the substantially constant thickness portion having the higher transmittance also has the lower optical haze (e.g., the higher transmittance portion can be substantially free of beads, dyes and pigments, while the other portion can include dyes and/or pigments for reducing transmittance and beads for scattering).

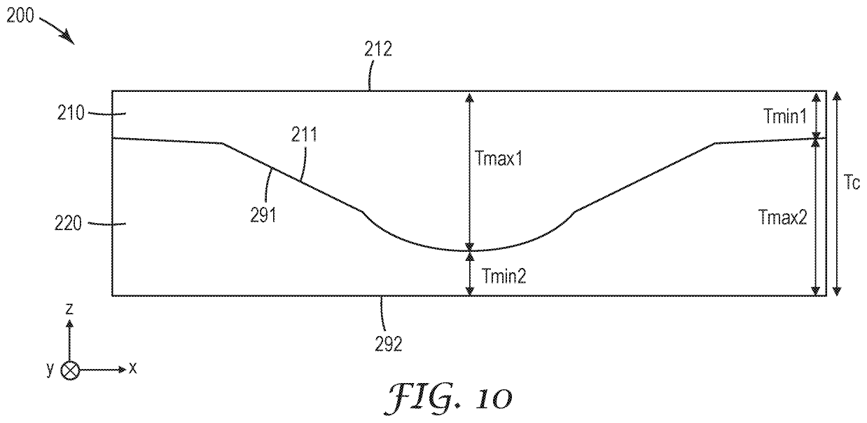

FIG. 10 is a schematic cross-sectional view of a film 200, according to some embodiments. The film 200 includes adjacent first and second layers 210 and 220 extending substantially uniformly along a length direction (y-direction) of the film and being substantially coextensive with one another. Each of the first and second layers 210 and 220 has a thickness varying along a width direction (x-direction) orthogonal to the length direction such that a combined thickness Tc of the first and second layers 210 and 220 is substantially constant (e.g., varying by less than 15%, or less than 10%, or less than 5%) along the width direction. In some embodiments, each of the first and second layers 210 and 220 has a maximum thickness (Tmax1, Tmax2) at least 1.2 times a minimum thickness (Tmin1, Tmin2) of the layer. In some embodiments, the first and second layers have different compositions and may be substantially permanently bonded to one another. In some embodiments, for each of the first and second layers 210 and 220, the maximum thickness of the layer is at least 1.5, 2, 2.5, 3, 4, 5, 6, or 7 times the minimum thickness of the layer. In some embodiments, for each of the first and second layers, the maximum thickness of the layer is no more than 50, 30, 20, or 15 times the minimum thickness of the layer.

In some embodiments, the film 100″ of FIG. 3, for example, may similarly be described as including adjacent first and second layers (portions 121 and 122, respectively) extending substantially uniformly along a length direction (y-direction) of the film and being substantially coextensive with one another, where each of the first and second layers has a thickness varying along a width direction (x-direction) orthogonal to the length direction such that a combined thickness of the first and second layers is substantially constant.

The film 200 can have one or more physical properties varying across the width of the film. This can arise from the layers 210, 220 having different physical properties resulting in the film 200 having physical properties varying across the width of the film due to the thickness variation of the layers 210, 220. For example, the layer 210 can include dye and/or pigment to reduce optical transmittance through the layer while the layer 220 can be substantially free of dye and pigment. This can result in the film 200 having a higher transmittance near the edges of the film where the layer 210 is thinnest and a lower transmittance near center locations along the width where the layer 210 is thickest. As another example, one but not the other of the layers 210, 220 may include beads for scattering resulting in an optical haze of the film 200 varying across the width of the film.

Layers or elements can be described as substantially coextensive with each other if at least about 60% by area of each layer or element is co-extensive with at least about 60% by area of each other layer or element. In some embodiments of layers or elements that are substantially coextensive with each other, at least about 80% or at least about 90% of each layer or element is co-extensive with at least about 80% or at least about 90% of each other layer or element. Layers or elements can be described as substantially coextensive with each other in length and/or width if at least about 60% of the length and/or width of each layer or element is co-extensive with at least about 60% of the length and/or width of each other layer or element. In some embodiments of layers or elements that are substantially coextensive with each other in length and/or width, at least about 80% or at least about 90% of each layer or element is co-extensive in length and/or width with at least about 80% or at least about 90% of the length and/or width of each other layer or element.

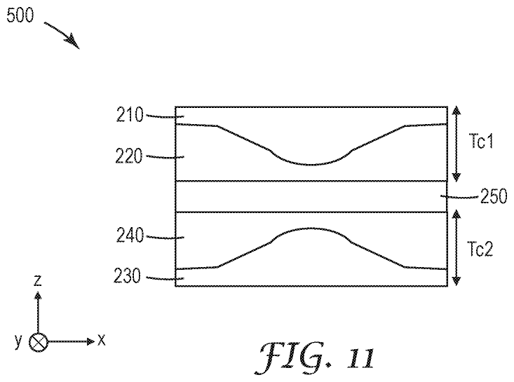

FIG. 11 is a schematic cross-sectional view of a film 500 including first through fourth layers 210, 220, 230, and 240, according to some embodiments. The layers 210 and 220 may be as described elsewhere and the layers 230 and 240 may be as described for layers 210 and 220. In some embodiments, the first through fourth layer 210, 220, 230, and 240 extend substantially uniformly along a length direction (y-direction) of the film and are substantially coextensive with one another. Each of the first through fourth layers can have a thickness varying along a width direction (x-direction) orthogonal to the length direction such that each of a combined thickness Tc1 of the first and second layers and a combined thickness Tc2 of the third and fourth layers is substantially constant along the width direction. In some embodiments, each of the first through fourth layers has a maximum thickness at least 1.2 times a minimum thickness of the layer (or the maximum to minimum thickness ratio can be in any range described elsewhere herein (see, e.g., FIG. 10)). In some embodiments, the first and second layers 210 and 220 are adjacent to one another and have different compositions, and the third and fourth layers 230 and 240 are adjacent to one another and have different compositions. The first and second layers 210 and 220 may be substantially permanently or releasably bonded to one another. Similarly, the third and fourth layers 230 and 240 may be substantially permanently or releasably bonded to one another. The film 500 can have one or more physical properties varying substantially continuously across a width of the film.

The thickness of the various layers and films can be in any suitable range that may depend on the intended application (e.g., as a skin layer for a multilayer optical film or as a self-supporting optical film). Any or all of the combined thicknesses Tc, Tc1, Tc2, or the thickness of any of the layers 110-110″″, can be greater than about 1, 1.5, 2, 2.5, 3, 4, 5, 10, or 15 micrometers. The combined thickness or the thickness of layers 110-110″″ can be up to about 2,000, 1,000, 500, 200, 100, 50, 40, or 30 micrometers, for example.

In some embodiments, each of the first and second layers 210, 220 has a non-planar first major surface 211, 291 and a substantially planar opposite second major surface 212, 292, where the non-planar first major surfaces of the first and second layers 210 and 220 face and substantially conform to one another (see, e.g., FIG. 10). Similarly, in some embodiments, each of the third and fourth layers 230 and 240 has a non-planar first major surface and a substantially planar opposite second major surface, where the non-planar first major surfaces of the third and fourth layers 230 and 240 face and substantially conform to one another.

In some embodiments, the first and second layers 210 and 220 define a first layer pair and the third and fourth layers 230 and 240 define a second layer pair, and the film 500 further includes a layer or film 250 disposed between the first and second layer pairs. The layer or film 250 can include a single layer, or a plurality of layers, or the layer or film 250 can optionally be omitted. The second layer 220, which is thinner near a center of the layer than edges of the layer in the illustrated embodiment, can be disposed between the first layer 210 and the layer or film 250 as illustrated in FIG. 11, or the order of the layers may be reversed so that the first layer 210 is disposed between the second layer 220 and the layer or film 250. Similarly, the fourth layer 240, which is thinner near a center of the layer than edges of the layer in the illustrated embodiment, can be disposed between the third layer 230 and the layer or film 250 as schematically illustrated in FIG. 11, or the order of the layers may be reversed so that the third layer 230 is disposed between the fourth layer 240 and the layer or film 250.

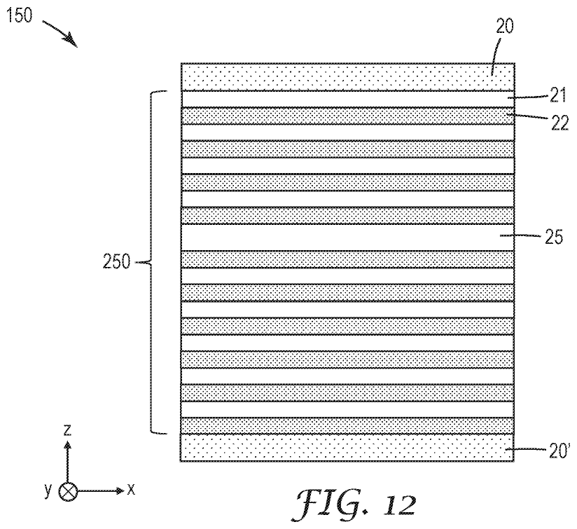

FIG. 12 is a schematic cross-sectional view of a film 150, according to some embodiments. The film 150 includes skins 20, 20′ which can correspond to any film, layer or layer pair described elsewhere herein. For example, skins 20, 20′ may independently correspond to any of films 100, 100′, 100″, 100′″, or 200. The layers between the skins 20, 20′ may be a film 250 of FIG. 11. One of the skins 20, 20′ may optionally be omitted. The film 150 includes a plurality of alternating layers 21, 22 disposed between the skins 20, 20′. The alternating layers 21, 22 may be optical layers. Optical layers are generally layers that reflect and transmit light primarily by optical interference. Optical layers may be described as reflecting or transmitting light primarily by optical interference when the reflectance and transmittance of the optical layers can be reasonably described by optical interference or reasonably accurately modeled as resulting from optical interference. As is known in the art, a film including a plurality of alternating optical layers can provide a desired reflection and transmission in desired wavelength ranges by suitable selection of layer thicknesses and refractive index differences. Such multilayer optical films and methods of making multilayer optical films are described in U.S. Pat. No. 5,882,774 (Jonza et al.); U.S. Pat. No. 6,179,948 (Merrill et al.); U.S. Pat. No. 6,783,349 (Neavin et al.); U.S. Pat. No. 6,967,778 (Wheatley et al.); and U.S. Pat. No. 9,162,406 (Neavin et al.), for example.

In some embodiments, a film 150 includes a plurality of alternating optical layers 21, 22 disposed on a film (e.g., skin 20 which may correspond to film 200 that includes first and second layers 210 and 220), where each of the optical layers has an average thickness less than about 500 nm. In some such embodiments, the film includes first and second layers 210 and 220 where a combined thickness Tc of the first and second layers is greater than about 1.5 micrometers. The skins 20, 20′ may correspond to respective layer pairs 210, 220 and 230, 240. In some embodiments, a film 150 includes first (210, 220) and second (230, 240) layer pairs and a plurality of alternating optical layers 21, 22 disposed between the first and second layer pairs, where each of the optical layers has an average thickness less than about 500 nm. The combined thickness Tc1 of the first and second layers can be greater than about 1.5 micrometers, and the combined thickness Tc2 of the third and fourth layers can be greater than about 1.5 micrometers. One of both of the skins 20, 20′ may correspond to any of first layers 110, 110′, 110″, 110′″, 100″″ for example. In some embodiments, the film 150 includes a plurality of alternating optical layers 21, 22 disposed on the first layer, where each of the optical layers has an average thickness less than about 500 nm and where the first layer has an average thickness T greater than about 1.5 micrometers.

In some embodiments, each of the optical layers 21, 22 has an average thickness less than about 400 nm, or less than about 300 nm, or less than about 250 nm, for example. Each of the optical layers 21, 22 may have a thickness greater than about 30 nm or greater than about 50 nm, for example. In some embodiments, at least one of the skins 20, 20′ has an average thickness (Tc, Tc1, or Tc2) greater than about 2 micrometers, or greater than about 3 micrometers, or greater than about 4 micrometers, for example. The at least one of the skins 20, 20′ may have an average thickness of up to 100 micrometers, or up to 50 micrometers or up to 30 micrometers, for example. In some embodiments, the film 150 includes additional layer(s), such as protective boundary layer(s), disposed between adjacent packets of alternating optical layers 21, 22. In the embodiment of FIG. 12, an additional layer 25 is illustrated. The additional layer(s) may each have an average thickness in any of the ranges described for the skins 20, 20′.

In some embodiments, the film 150 includes a plurality of alternating optical layers 21, 22 numbering at least 10, 20, 30, 50, or 50 in total. The optical layers 21, 22 can number up to 1500 or 1000 in total, for example.

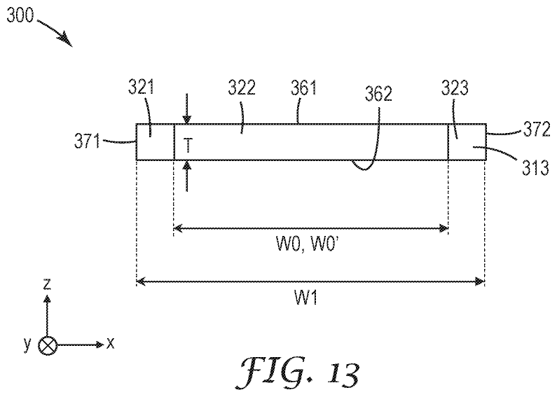

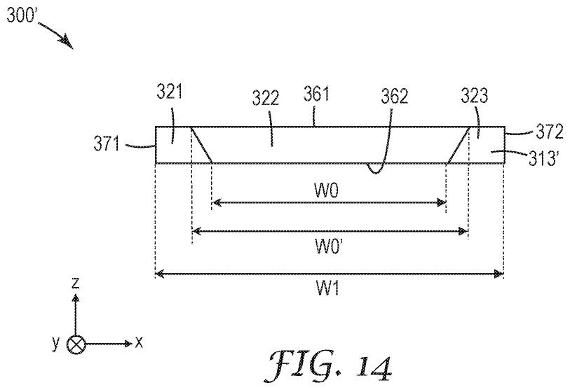

FIGS. 13-14 are schematic cross-sectional views of films 300 and 300′, according to some embodiments. The film 300, 300′ includes a first layer 313 having opposing first and second major surfaces 361 and 362 separated along a thickness direction (z-direction) of the film. The first layer 313, 313′ include first (321), second (322) and third (323) portions extending between the first and second major surfaces and being substantially coextensive with the first layer along a length direction (y-direction) of the film. The first and third portions 321 and 323 are separated along a width direction (x-direction), which is orthogonal to the length and thickness directions, of the film and are disposed adjacent respective opposing first and second lateral edges 371 and 372 of the first layer. For example, the first and third portions 321 and 323 can comprise the respective first and second lateral edges 371 and 372. The second portion 322 is disposed between and contacting the first and third portions 321 and 323. The second portion 322 may be (e.g., permanently) bonded to the first and third portions 321 and 323. In some embodiments, the second portion extends substantially uniformly over a width W0 (e.g., substantially constant thickness and substantially uniform composition over the width) along the width direction of the film, where the first layer has an average thickness T, and where W0/T>100. W0/T may be greater than 200, 500, 1000, 2000, 4000, or 5000, for example. W0/T may be up to 100,000, or up to 50,000, or up to 30,000, for example. The first, second, and third portions 321, 322, 323 can comprise respective first, second, and third compositions, where the second composition is different from each of the first and third compositions. The first and third compositions can be the same or different.

In some embodiments, the width W0 is greater than half of, or greater than about 0.6 times, or greater than 0.7 times, or greater than 0.8 times a width W1 of the film along the width direction. The width W0 may be up to about 0.995, or up to about 0.99, or up to about 0.98, or up to about 0.97 times the width W1.

In some embodiments, the first and third portions 321 and 323 have substantially vertical sidewalls adjacent the second portion 322 as schematically illustrated in FIG. 13. In some embodiments, one or both of the first and third portions 321 and 323 have tapered sidewalls adjacent the second portion 322 as schematically illustrated in FIG. 14. The tapering can be as described elsewhere herein (see, e.g., FIGS. 1-5). The width of the second portion 322 that includes the tapering portions is denoted W0′ in FIG. 14, while the width of the substantially constant thickness portion of the second portion 322 is denoted W0 in FIG. 14.

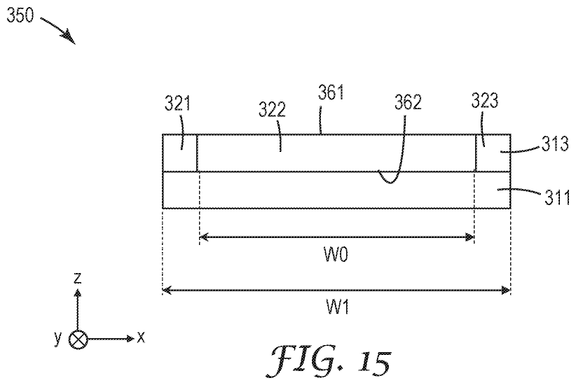

The film 300, 300′ can further include an additional layer or additional layers and/or can include additional first layers 313. For example, the film 300, 300′ can further include a plurality of alternating polymeric layers (see, e.g., FIG. 12) disposed on the first layer 313. FIGS. 15-17 are schematic cross-sectional views of the respective films 350, 400, and 450, according to some embodiments. The layer 313 schematically illustrated in these figures corresponds to the layer 313 of FIG. 13. In other embodiments, the layer of FIG. 14 is instead included in place of at least some of the layers 313 of FIG. 13. In some embodiments, the film further includes a (e.g., birefringent) second layer 311 that may be coextruded and co-stretched with the first layer 313. In some embodiments, the film further includes second and third layers 311 and 312 which can be substantially coextensive with the first layer 313 along the length and width directions, where the first layer 313 is disposed between the second and third layers 311 and 312.

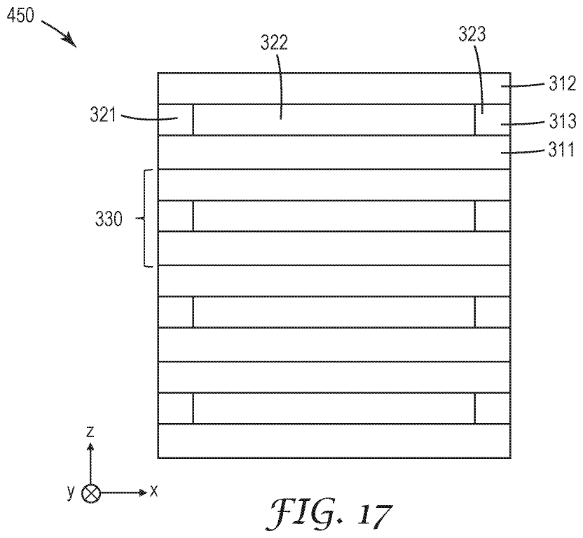

The multiple portions of the layer 313 can be selected to provide a tailored bonding (e.g., as quantified by a peel force) with an adjacent layer. For example, in some embodiments, the first and second portions 321 and 322 have different bond strengths with the second layer 311, and each of the first and second portions 321 and 322 has a bond strength with the third layer 312 greater than each of the different bond strengths with the second layer 311. The bond strength can be adjusted by suitable selection of polymers for the various layers and layer portions. For example, polymers with similar monomer units tend to bond well to one another, while low surface energy polymers tend to bond weakly with other polymers not having similar monomer units. Blends of polymers or copolymers with different monomer units may be used to adjust the bonding. For example, the layer 311 can be a PET layer and the layer 312 can be a PETG layer. Portion 321 and optionally portion 323 of layer 313 can be formed from PETG or a blend of PETG and PP, for example, while portion 322 can be formed from a blend of PP and SEBS copolymer, for example. Layers 311 and 312 can then have good bonding to one another (see, e.g., FIG. 17) and to each of the portions 321 and 323. Portion 322 can have good bonding to layer 312 but poor bonding to layer 311, for example. For example, it may be desired that (e.g., edge) portions 321 and 323 have good bonding to adjacent layers but that once a peel has been initiated at the edge(s), that portion 322 have a low peel strength with layer 311 so that layer 313 can be readily removed from layer 311 once peeling from the edge(s) has been initiated.

In some embodiments, a film 350 includes a coextruded plurality of polymeric layers extending along a length direction (y-direction) of the film. The plurality of polymeric layers includes a birefringent first layer 311 and a second layer 313 disposed on the first layer 311. The second layer 313 has opposing first and second major surfaces 361 and 362 separated along a thickness direction of the film. The film 350 may include only two layers as schematically illustrated in FIG. 15, or more layers (e.g., the alternating layers schematically illustrated in FIG. 12) may be included. The second layer 313 includes adjacent first 321 and second 322 portions extending between the first and second major surfaces and being substantially coextensive with the second layer along the length direction. The first and second portions 321 and 322 can have different compositions. The second layer 313 may also include a third portion 323 where the second portion 322 is disposed between the first and third portions 321 and 323. The second and third portions 322 and 323 can have different compositions. The first and third portions 321 and 323 can have a same composition or can have different compositions. The birefringent first layer 311 may have an average birefringence of at least 0.05, or at least 0.1, or at least 0.15, for example. The average birefringence may be up to 0.4, or up to 0.35, or up to 0.3, or up to 0.26, for example. The average birefringence is the birefringence averaged (unweighted mean) over locations of the layer. The birefringence at a location is the difference between the maximum and minimum refractive indices at the location. The refractive indices can be understood to be evaluated at a wavelength of 550 nm, unless indicated otherwise. The birefringent first layer 311 may be substantially uniformly birefringent.

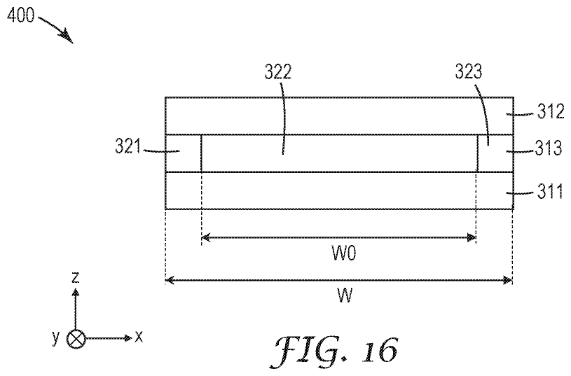

FIG. 16 is a schematic cross-sectional view of a film 400 including substantially coextensive first (311), second (312) and third (313) layers extending substantially uniformly along a length direction (y-direction) of the film, according to some embodiments. Note that the various layers may alternatively be labeled differently (e.g., as in the embodiments of FIGS. 14-15). The third layer 313 is disposed between the first and second layers 311 and 312. The third layer 313 includes first and second portions 321 and 322 substantially coextensive with the third layer along the length direction and arranged along a width direction (x-direction) orthogonal to the length direction. In some embodiments, the first and second portions 321 and 322 have different bond strengths with the first layer 311, and each of the first and second portions 321 and 322 has a bond strength with the second layer 312 greater than each of the different bond strengths with the first layer 311. The third layer 313 may also include a third portion 323 that is substantially coextensive with the third layer along the length direction, where the second portion 322 is disposed between the first and third portions 321 and 323. The first and third portions 321 and 323 may be disposed along opposite lateral edges of the layer 313. In some embodiments, the first layer 311 is birefringent, as described further elsewhere herein.

A film can be a free-standing film or can be part of a multilayer film or stack. For example, the film 400 may be a free-standing film or may be a three-layer portion of a multilayer film that includes additional layers.

FIG. 17 is a schematic cross-sectional view of a multilayer film 450 which includes a plurality of first repeat units 330, according to some embodiments. Each first repeat unit 330 may be or include a film 400. In some embodiments, the multilayer film 450 includes a plurality of second repeat units. For example, the multilayer film 450 may include a plurality of the first repeat units 330 disposed on a plurality of second repeat units where each second repeat unit include a pair of optical layers 21, 22 (e.g., one or both of the skins 20, 20′ of FIG. 12 may be a multilayer film 450). The plurality of first repeat units may number at least 2, 3, 4, or 5 in total. The total number of first repeat units is not particularly limited but may be no more than 100, 50, or 40, in some embodiments.

A film with spatially varying release properties can be useful in a variety of applications where control in peel strength is desired. For example, in some applications, it is desired that layers stay with a device until a component needs to be replaced and then the film allows the component to be removed (e.g., with a layer of the film) from the device. Example application areas include electronic component replacement (e.g., cell phone screens) and vehicle component replacement (e.g., electronic vehicle battery cells).

Various films and layers of the present description can be made via extruding molten polymeric materials through a die. Such methods of making a film are generally described in U.S. Pat. Appl. Pub. Nos. 2007/0154683 (Ausen et al.) and 2020/0189164 (Free et al.), for example, and in U.S. Pat. No. 9,162,406 (Neavin et al.), for example. The film can optionally be stretched (e.g., in a standard or parabolic tenter) to impart birefringence to various layers of film. For example, layers formed from semi-crystallizable polymer can become birefringent upon stretching (e.g., uniaxially or biaxially) and heat setting, as is known in the art. Coextrusion followed by stretching of multilayer films are described in U.S. Pat. No. 5,882,774 (Jonza et al.); U.S. Pat. No. 6,179,948 (Merrill et al.); U.S. Pat. No. 6,783,349 (Neavin et al.); U.S. Pat. No. 6,967,778 (Wheatley et al.); and U.S. Pat. No. 9,162,406 (Neavin et al.), for example.

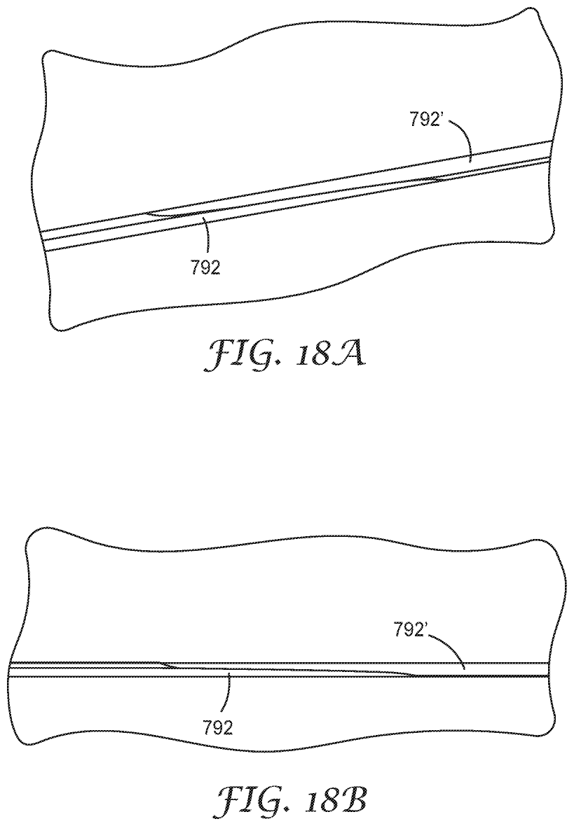

In some embodiments, films or layers are made using feed blocks including a die having a profiled gap for defining the transition across the width of a layer. Such dies may be made using standard machining techniques, for example. Dies with profiled gaps are generally described in U.S. Pat. Appl. Pub. No. 2020/0189164 (Free et al.), for example. FIG. 18A is a schematic perspective view of a portion of a feed block including profiled gaps 792, 792′ for forming a layer having a gradual transition between portions on opposite lateral sides of the layer (see, e.g., FIGS. 1-3), according to some embodiments. FIG. 18B is a schematic end view of a portion of the feed block of FIG. 18A. Additional transition regions in the film can be formed using dies including corresponding additional profiled gaps. More generally, a layer having multiple portions or sections can be formed by using a die including corresponding multiple output sections with desired tapering between adjacent output sections.

The feed block can make a single layer or plurality of layers. For example, the dies of FIGS. 18A-18B can be used to make a single layer film or can be used with other feed block components to make a multilayer film including at least one gradually transitioning layer.

In some embodiments, a method of making a film is provided. The method can include extruding first and second thermoplastic polymer compositions through a die (see, e.g., FIG. 18A-18B) along a length direction to form a layer of the film, where the die includes adjacent first and second profiled gaps 792 and 792′ defining respective first and second portions of the layer. The geometry of the profiled gaps 792 and 792′ can be such that the resulting layer has any of the geometries described elsewhere herein. For example, each of the first and second portions can include a tapering portion having a thickness tapering in a width direction orthogonal to the thickness direction, where the tapering portions of the first and second portions can have respective first and second major surfaces substantially conforming to one another. For example, the layer formed by the method can be any of layers 110-110″″.

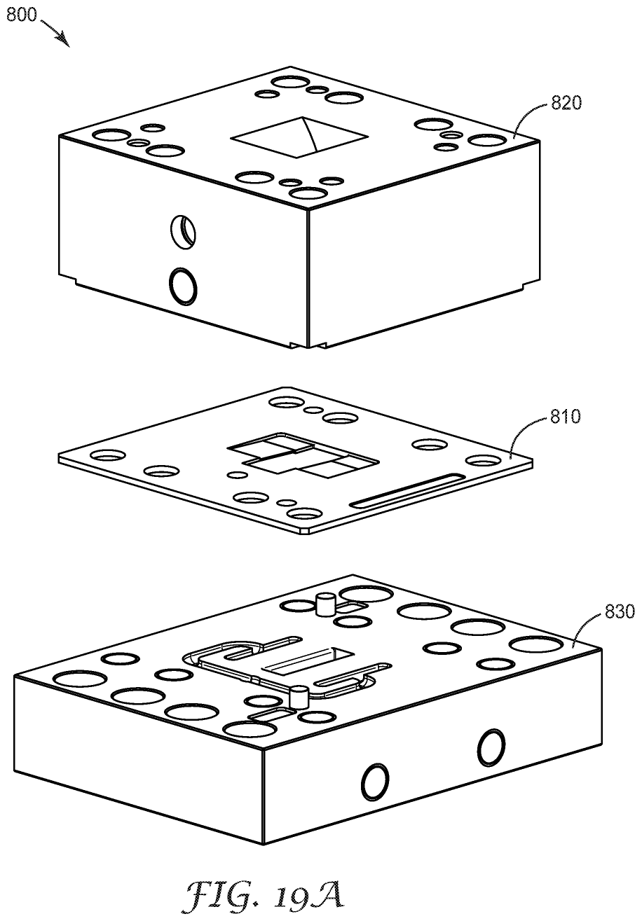

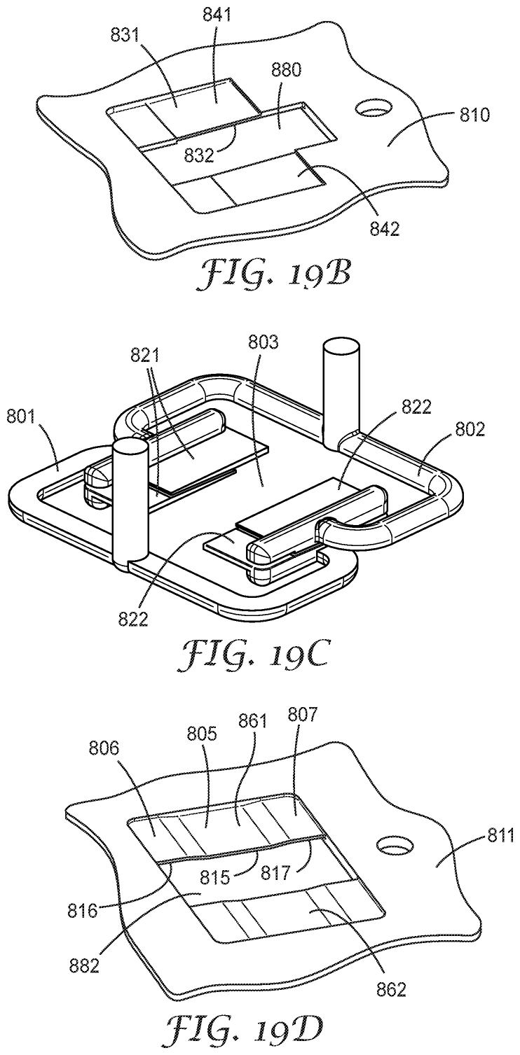

FIG. 19A is a schematic exploded view of a skin die 800 including a plate 810 for forming profiled skin layers on opposite sides of a layer or a multilayer stack, according to some embodiments. The plate 810 may be a shim or spacer element. A shim is generally a spacer element adapted to hold adjacent elements apart at a fixed distance determined by the thickness of the shim. The plate 810 is disposed between a skin block 820 and a die adapter 830. FIG. 19B is an enlarged schematic perspective view of a portion of the plate 810. FIG. 19C is a schematic perspective view of fluid flow paths created in the skin die 800 for resins 801 and 802. The plate 810 has patterns cut into the top and bottom of the plate to provide the illustrated flow profiles on the top and bottom of the plate. The illustrated flow patterns form a layer such as that schematically illustrated in FIG. 1, for example, on opposite sides of a layer or stack of layers formed in the region 803 by a feed block including the skin die 800. FIG. 19D is a schematic perspective view of a portion of a plate 811, according to some embodiments, that maybe used in skin die 800 in place of plate 810 for making skins having layers with varying thickness profiles but a constant combined total thickness (e.g., each skin can correspond to film 200 so that the final film can correspond to film 500). For example, the plate 811 provides a thicker center region 805 and thinner edge regions 806 and 807 for resin (e.g., corresponding to resin 801) provided on the top surface of the plate 811 and a thinner center region 815 and thicker edge regions 816 and 817 for resin (e.g., corresponding to resin 802) provided on the bottom surface of the plate 811.

In some embodiments, a of making a film is provided. The method includes directing first and second molten polymeric compositions (e.g., corresponding to resins 801 and 802) across opposing major surfaces (e.g., major surfaces 831 and 832 of portion 841 of plate 810, or the top major surface of portion 861 of plate 811 defining regions 805, 806, 807 and the bottom major surface of portion 861 of plate 811 defining regions 815, 816 and 817) of a first portion (e.g., portion 841 of plate 810 or portion 861 of plate 811) of a shaped spacer element (e.g., corresponding to plate 810 or 811) to define a first molten stream 821 having a shaped interface between the first and second molten polymeric compositions; and extruding the first molten stream 821 to form at least one first layer of the film. The at least one first layer can correspond to any of layers 110-110″″ or can correspond to layers 210 and 220, for example. The method may include directing the first and second molten polymeric compositions, or third and fourth polymeric compositions, across opposing major surfaces of a second portion (e.g., portion 842 of plate 810 or portion 862 of plate 811) of the shaped spacer element to define a second molten stream 822 which can be extruded to form at least one second layer of the film. The at least one first layer of the film can correspond to layers 210 and 220, for example, and the at least one second layer of the film can correspond to layers 230 and 240, for example. The method can further include forming at least one third layer between the at least one first layer and the at least one second layer. For example, the at least one third layer can correspond to layer or film 250 of FIG. 11 or 12. The shaped spacer element 810 (resp., 811) may define an opening 880 (resp., 882) between the first and second portions 841 and 842 (resp., 861 and 862) of the shaped spacer element. The method may include providing at least one molted stream corresponding to the at least one third layer through the opening 880, 882. The shaped spacer element can include substantially planar portion (e.g., sufficiently planar that the substantially planar portion is useful as constant thickness spacer) surrounding the first and second portions and the opening. The shaped spacer element can be disposed between first and second die elements (e.g., skin block 820 and die adapter 830) to hold the elements part at a predetermined distance which can correspond to the thickness of the substantially planar portion of the shaped spacer element. The shaped spacer element may be referred to as a shaped shim or a shaped plate or simply as a plate. The molten polymeric compositions may be referred to as resins. Each of the molten polymeric compositions can be a molten polymer or a molten polymer blend.

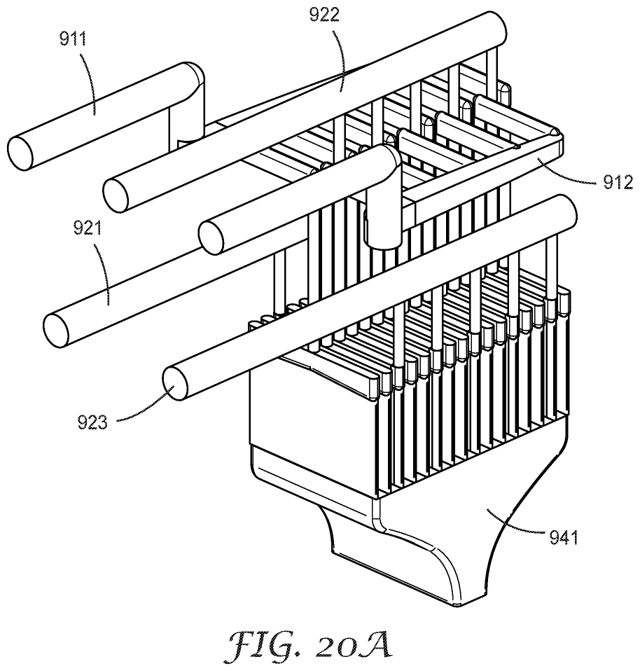

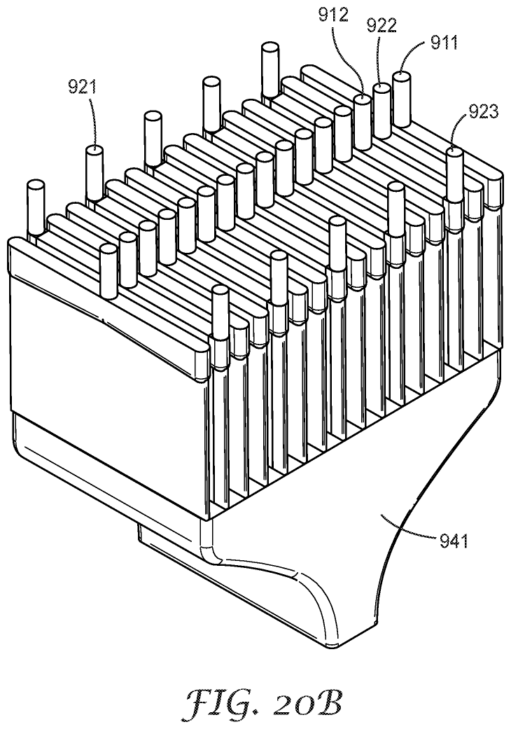

The feed block can be designed to provide additional layers and/or portions of layers. FIG. 20A a schematic perspective view of fluid flow paths created in a feed block for making a film that can correspond to film 450, for example, according to some embodiments. FIG. 20B is a schematic perspective view of a portion of the fluid flow paths of FIG. 20A. Resin flows 911, 912, 921, 922, 923, which can correspond to layers or portions 311, 312, 321, 322, 323, respectively, are illustrated. The feed block can be constructed to provide the resin flows 911, 912, 921, 922, 923 using conventional feed block design techniques, as would be appreciated by the person of ordinary skill in the art. In the illustrated embodiment, the feed block includes an optional compression section 941 to reduce the thickness of the layers of the resulting multilayer film. The output from the feed block may be fed into a conventional single manifold film die (e.g., from Nordson, Cloeren, etc.) where the layers are spread in the width direction and made thinner.

In some embodiments, a of making a film is provided. The film includes at least first (311), second (312) and third (313) layers where the third layer is disposed between the first and second layers and where the third layer includes first (321) and second (322) portions. The method includes coextruding the at least first (311), second (312) and third (313) layers. Coextruding the at least first, second, and third layers includes coextruding at least the first and second portions 321 and 322 to form the third layer 313. The first and second portions can have different bond strengths with the first layer. Each of the first and second portions can have a bond strength with the second layer greater than each of the different bond strengths with the first layer. Coextruding the at least first, second, and third layers can include provide a melt stream including first, second and third molten layers corresponding to the first, second, and third layers of the film. The method can include compressing the melt stream in at least a thickness direction of the melt stream (e.g., in compression section 941).

### EXAMPLES

Films with varying components across width and or thickness were prepared and tested. Optical properties were measured and are shown in the following examples.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: mils=thousands of an inch, um=micrometer, mm=millimeter, m=meter, min=minute, ° C.=Centigrade, sec=seconds, %=percent, in =inch, H %=percent haze, C %=percent clarity, T %=percent transmission, IV=intrinsic viscosity, V=volts, N=Newton, g/in =grams/inch, g=gram.

TABLE 1
Materials

| Abbreviation | Description |
|---|---|
| PET | Polyethylene terephthalate, Laser + C 9921, a 0.80 IV PET available from |
| | DAK Americas, Chadds Ford, PA |
| PET AA48 | Polyethylene terephthalate resin available under the tradename AA48 from |
| | Nanya Technology, Taiwan |
| MB1 | Master Batch 1, PET with 2.5% CERES Blue XR-RF dye. CERES Blue XR- |
| | RF available from Lanxess, Cologne Germany |
| MB2 | Master Batch 2, PET with 1.5% carbon black. As described in Example |
| | Masterbatch B from U.S. Pat. No. 6,811,867 (McGurran et al.) |
| SBX-8 | Polystyrene beads, 8 um diameter, available as Techpolymer SBX-8 from |
| | Sekisui Plastics Co., Tokyo, Japan |
| PETG | Glycol-modified PET available under the tradename GN071 from Eastman |
| | Chemical Company, Kingsport, TN |
| PP8650 | a ~10 melt flow index (MFI) co-polypropylene with 7% Ethylene available |
| | from Total Petrochemicals, Inc., Huston, TX) |
| KRATON | Styrene-ethylene/butylene-styrene (SEBS) block copolymer available from |
| G1657 | KRATON Polymers, Houston, TX |

### Test Methods

### Optical

Percent transmission, clarity and haze measurements were taken on a BYK haze-gard plus (BYK Instruments USA, Columbia, MD).

### Peel

Peel tests were carried out using an IMASS SP-2100 (IMASS, Inc. Accord, PA) in a 90° configuration with a 10 pound (44 N) load cell at a rate of 12 inch/minute.

### Examples E1-E6 and Comparative Example C1

Multicomponent films with components transitioning from the left to right across their width (e.g., similar to film 100) were prepared using 2 twin-screw extruders (TSE) feeding into an 8-inch (203.2 mm) wide, two manifold die. The die had a replaceable point of confluence where the two manifolds came together. On the left edge of the die, the layer A channel (channel feeding gap 792 on the left-hand side of FIGS. 18A-18B) had a 0.100 in (2.5 mm) gap over a 2.5 in (63.5 mm) width while the layer B channel had zero gap (sealed off). On the right edge of the die, the A channel was sealed off while the B channel (channel feeding gap 792′ on the right-hand side of FIGS. 18A-18B) had a 0.100 in (2.5 mm) gap over a 2.5 in (63.5 mm) width. In the 3 in (76 mm) region between the two edges, the A channel began to taper down from the 0.100 in (2.5 mm) gap while the B channel began to open up as shown in FIGS. 18A-18B. The mass flow through the gap was proportional to the gap dimension cubed. The design shown in FIGS. 18A-18B was designed to give a linear gradient between the two materials.

The left (layer A channel) side of the die was fed by a 25 mm Berstorff TSE run under vacuum and utilized a progressive temperature profile with an 8/0 temperature of 271° C. The associated gear pump and neck tube also were heated to 271° C. The feed rate was 10 pounds/hour. The right (layer B channel) side of the die was fed by a 27 mm Leistritz TSE which was run under vacuum and also utilized a progressive temperature profile with an 8/0 temperature at 271° C. The associated gear pump and neck tube also were heated to 271° C. The feed rate was 10 pounds/hour. The 8 inch (203.2 mm) feed block/die was also heated to 271° C. The resulting multicomponent coextrusion flowed from the die and was cast onto a chilled casting wheel held at 27° C. with an electrostatic pinning wire running at 9V. Film thickness ranged from 12 to 36 mils.

These films were in turn oriented on a KARO IV (Bruckner Maschinenbua GmbH and Co., Siegsdorf Germany) batch orienter using a stretch profile with a heat soak of 45 sec, an orientation temperature of 100° C., and an orientation ratio of 350%×350% and an orientation rate of 50%/sec. These films were also annealed in an oven at 225° C. for 15 sec. Table 2 below provides the resin composition of the Multicomponent Films and the resulting side-to-side differences in optical properties of these oriented Multicomponent Films.

TABLE 2
Examples E1-E6 and C1 Composition and Results

| | Left | Right | Right | Right | Right | Left | Left | Left |
|---|---|---|---|---|---|---|---|---|
| | side resin | side resin | side | side | side | side | side | side |
| Example | (A) | (B) | % T | % H | % C | % T | % H | % C |
| E1 | PET | PET + 20% MB1 | 80.3 | 0.20 | 99.8 | 89.7 | 0.29 | 99.8 |
| C1 | PET | PET | 89.8 | 0.21 | 100 | 89.7 | 0.18 | 99.7 |
| E2 | PET | PET + 10% MB2 | 89.8 | 0.21 | 99.8 | 41.5 | 2.90 | 99.6 |
| E3 | PET | PET + 20% MB2 | 89.6 | 0.34 | 99.6 | 15.6 | 9.61 | 97.2 |
| E4 | PET | PET + 30% MB2 | 89.8 | 0.32 | 99.7 | 10.0 | 15.3 | 91.3 |
| E5 | PET + 2% | PET + 20% MB2 | 87.5 | 75.9 | 11.9 | 18.9 | 9.32 | 98 |
| | SBX-8 | | | | | | | |
| E6 | PET + 2% | PET | 85.9 | 76.2 | 19.5 | 89.8 | 1.19 | 99.7 |
| | SBX-8 | | | | | | | |

A strip of oriented/annealed film from E2 was placed into a Microtek ArtixScan F2 (Microtek Hsinchu, Taiwan). A grayscale file with a resolution level of 300 datapoints per inch was generated from this strip of film and converted to an Excel file for further evaluation. This was utilized to further characterize the transition in the film from a high % T to a lower % T film as shown in FIG. 9.

### Example E7

A multilayered film (e.g., similar to film 200) with component layer thickness transitioning from one side of the die to the center, then back again were prepared using the feed block/die described in Example 1 of U.S. Pat. Pub. No. 2020/0189164 A1 (Free et Al.). The middle hump side (Layer A, corresponding to layer 210) of the die was fed by a 25 mm Berstorff TSE which was run under vacuum and utilized a progressive temperature profile with an 8/0 temperature of 271° C. The associated gear pump and neck tube also were heated to 271° C. This extruder was fed with PET at 14.5 pounds/hour and MB-1 at 0.5 pounds/hour. The skinny middle side (Layer B, corresponding to layer 220) of the feed block/die was fed by a 27 mm TSE which was run under vacuum and also utilized a progressive temperature profile with an 8/0 temperature at 271° C. The associated gear pump and neck tube also were heated to 271° C. This extruder was feed with 4 pounds/hour PETG and 1 pounds/hour SBX-8. The 8 inch wide (203.2 mm) feed block/die was also heated to 271° C. The resulting multilayered coextrusion flowed from the die and was cast onto a chilled casting wheel held at 27° C. with an electrostatic pinning wire running at 9V. Film thickness ranged from 12 to 24 mils.

These films were in turn oriented on a KARO IV (Bruckner Maschinenbua GmbH and Co., Siegsdorf Germany) batch orienter using a stretch profile with a heat soak of 45 sec, an orientation temperature of 100° C., and an orientation ratio of 350%×350% and an orientation rate of 50%/sec. The edge portions of this film exhibited a % T/% H/% C combination of 60.9%/98.0%/62%. The center portion of this film exhibited a % T/% H/% C combination of 71.5%/76.7%/24.5%.

### Examples E8-E11

A series of films similar to the film of FIG. 17 were produced using a 16-layer feed block producing the flow pattern of FIGS. 20A-20B. Table 3 summarizes the resins used in making the films. In Table 3, “A” layers correspond to layers 311 and resin 911, “B” layers correspond to layers 312 and resin 912, “C” domains correspond to portions 322 of layers 313 and to resin 922, and “D” domains correspond to portions 321 and 323 of layers 313 and to resins 921 and 923, referring to FIGS. 17 and 20A-20B.

TABLE 3

| | A Layer | B Layer | C Domain | D Domain |
|---|---|---|---|---|
| Example | Composition | Composition | Composition | Composition |
| E8 | 20 pound/hour | 7 pound/hour | 4.8 pound/hour | 2 pound/hour |
| | PET AA48 | PETG | PP8650, 1.2 | PP8650, |
| | | | pound/hour | 2 pound/hour |
| | | | KRATON | PETG |
| | | | G1657 | |
| E9 | 20 pound/hour | 7 pound/hour | 4 pound/hour | 5 pound/hour |
| | PET AA48 | PETG | PP8650, | PETG |
| | | | 1 pound/hour | |
| | | | KRATON | |
| | | | G1657 | |
| E10 | 20 pound/hour | 7 pound/hour | 4 pound/hour | 1 pound/hour |
| | PET AA48 | PETG | PP8650, | PP8650, |
| | | | 1 pound/hour | 4 pound/hour |
| | | | KRATON | PETG |
| | | | G1657 | |
| E11 | 20 pound/hour | 7 pound/hour | 4 pound/hour | 2 pound/hour |
| | PET AA48 | PETG | PP8650, | PP8650, |
| | | | 1 pound/hour | 3 pound/hour |
| | | | KRATON | PETG |
| | | | G1657 | |

The materials combination described in Table 3 were combined into films via the following process and equipment combination: The “A” layers of the 16 layer stack were fed by a 27 mm TSE which was run under vacuum and utilized a progressive temperature profile with an 8/0 temperature of 277° C. and utilized PET AA48 resin at a rate of 20 pounds/hour. The associated gear pump and neck tube also were heated to 277° C. The “B” layers of the 16 layer stack were fed by a 32 mm single screw extruder (SSE) which was run using a progressive temperature profile with an 8/0 temperature of 260° C. and fed dried PETG GN071 resin at a rate of 7 pounds/hour. The associated neck tube was also were heated to 260° C. The “C” Domains of the peel layers in the 16 layer feed block were fed by a 27 mm TSE which utilized a progressive temperature profile with an 8/0 temp of 271° C. and fed 80/20 wt % blends of PP8650 and KRATON G1657. The total feed rate varied from 5 to 6 pounds/hour (see Table 3) depending on condition. The associated gear pump and neck tube also were heated to 271° C. The “D” Domains of the peel layers in the 16 layer feed block were fed by a 25 mm TSE which utilized a progressive temperature profile with an 8/0 temp of 260° C. and fed various blend ratios blends of PP8650 and PETG. Total feed rate varied from 4 to 5 pounds/hour (see Table 3) depending on condition. The associated gear pump and neck tube also were heated to 260° C.

The feed block/die was heated to 277° C. The 20 cm die was positioned just above a 27° C. rotating chill roll with associated electrostatic pinning for rapid web quenching. These 16 layered films were produced on this equipment with cast web thicknesses of 17, 34, and 51 mils for each documented materials combination.

Some cast webs were oriented on a KARO IV (Bruckner Maschinenbua GmbH and Co., Siegsdorf Germany) batch orienter using a stretch profile with a heat soak of 90 sec, an orientation temp of 100° C., at an orientation ratio of 350%×350% and an orientation rate of 50%/sec. In some cases, these films were also annealed in an oven at 225° C. for 15 sec.

These films were then evaluated for delamination/peel force in the C domain vs. D domain areas of the film. When these films delaminated, the delamination occurred between an A layer and the peel layer (either the C domain or the D domain). Table 4 describes the delamination forces recorded for the C vs. D domains.

TABLE 4

| | A to C Domain Peel Force | A to D Domain Peel Force |
|---|---|---|
| Example | (g/in) | (g/in) |
| E8 | 15 | 69 |
| E9 | 18 | n/a |
| E10 | 15 | n/a |
| E11 | 16 | 104 |

As can be seen from Table 4, when delamination was conducted on a portion of the film containing a “C” domain of the peel layer, peel forces of 15-18 g/in were recorded. When delamination was conducted on a portion of the film containing a “D” domain of the peel layer, peel forces of 69 g, 104 g, and undelamable (n/a designation represents undelamable) were achieved.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. A film comprising a first layer having opposing first and second major surfaces separated along a thickness direction of the film, the first layer comprising coextruded first, second and third portions extending between the first and second major surfaces and being substantially coextensive with the first layer along a length direction of the film, the first and third portions separated along a width direction of the film and disposed adjacent respective opposing first and second lateral edges of the first layer, the width direction being orthogonal to the length and thickness directions, the second portion disposed between and contacting the first and third portions, the second portion extending substantially uniformly over a width W0 along the width direction of the film, the first layer having an average thickness T, the first, second, and third portions comprising respective first, second, and third compositions, the second composition different from each of the first and third compositions, wherein W0/T>100.

17. The film of claim 16, wherein the width W0 is greater than half of a width W1 of the film along the width direction.

18. The film of claim 16 further comprising a birefringent second layer coextruded and co-stretched with the first layer.

19. The film of claim 16 further comprising second and third layers substantially coextensive with the first layer along the length and width directions, the first layer disposed between the second and third layers, the first and second portions having different bond strengths with the second layer, each of the first and second portions having a bond strength with the third layer greater than each of the different bond strengths with the second layer.

20. The film of claim 16 further comprising a plurality of alternating first and second polymeric layers disposed on, and coextruded with, the first layer.

21. A film comprising a plurality of coextruded polymeric layers extending along a length direction of the film, the plurality of polymeric layers comprising a birefringent first layer and a second layer disposed on the first layer, the second layer having opposing first and second major surfaces separated along a thickness direction of the film and comprising adjacent first and second portions extending between the first and second major surfaces and being substantially coextensive with the second layer along the length direction, the first and second portions having different compositions.

22. The film of claim 21, wherein the second layer further comprises a third portion extending between the first and second major surfaces and being substantially coextensive with the first layer along the length direction of the film, the first and third portions separated along a width direction of the film and disposed adjacent respective opposing first and second lateral edges of the second layer, the width direction being orthogonal to the length and thickness directions, the second portion disposed between and contacting the first and third portions, the second portion extending substantially uniformly over a width W0 along the width direction of the film, the first layer having an average thickness T, the first, second, and third portions comprising respective first, second, and third compositions, the second composition different from each of the first and third compositions, wherein W0/T>100.

23. The film of claim 21 further comprising a plurality of alternating first and second optical layers disposed on, and coextruded with, the plurality of polymeric layers.

24. A film comprising coextruded substantially coextensive first, second and third layers extending substantially uniformly along a length direction of the film, the third layer disposed between the first and second layers, the third layer comprising first and second portions substantially coextensive with the third layer along the length direction and arranged along a width direction orthogonal to the length direction, the first and second portions having different bond strengths with the first layer, each of the first and second portions having a bond strength with the second layer greater than each of the different bond strengths with the first layer.

25. The film of claim 24 further comprising a plurality of alternating first and second optical layers disposed on, and coextruded with, the first, second and third layers.

26. A multilayer film comprising a plurality of coextruded first repeat units repeating along a thickness direction of the multilayer film, each first repeat unit comprising a film according to claim 24.

27. The multilayer film of claim 26 further comprising a plurality of alternating first and second optical layers disposed on, and coextruded with, the first repeat units.
